(19) United States
(12) Patent Application Publication
(10) Pub. No.: US 2025/0044556 A1
(43) Pub. Date: Feb. 6, 2025

(54) OPTICAL SYSTEM AND CAMERA MODULE COMPRISING SAME

(71) Applicant: LG INNOTEK CO., LTD., Seoul (KR)

(72) Inventor: Eun Sung SEO, Seoul (KR)

(21) Appl. No.: 18/718,099

(22) PCT Filed: Dec. 8, 2022
(86) PCT No.: PCT/KR2022/019927

§ 371 Date: Jun. 10, 2024

(30) Foreign Application Priority Data
Dec. 9, 2021 (KR) 10-2021-0176136

(51) Int. Cl. G02B 13/00; G02B 15/14

(52) U.S. Cl. CPC G02B 13/0045; G02B 13/006; G02B 13/0065; G02B 15/1421

(57) ABSTRACT

The optical system disclosed in the embodiment includes first to seventh lenses disposed along an optical axis from an object side to a sensor side, the first lens has positive (+) refractive power on the optical axis, and the second lens has a negative (−) refractive power on the optical axis, the seventh lens has a negative (−) refractive power on the optical axis, an object-side surface of the first lens has a convex shape on the optical axis, a sensor-side surface of first lens is bonded to the second lens, a sensor-side surface of the seventh lens has a largest effective aperture among the first to seventh lenses, and a distance in the optical axis from an apex of the object-side surface of the first lens to an image surface of an image sensor is TTL, ½ of a maximum diagonal length of the image sensor is ImgH, a refractive index of the first lens is n1, a refractive index of the second lens is n2, and the following equations may satisfy: 0.4<TTL/ImgH<3 and 0.05<(n2)−(n1)<0.25

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement. The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses. In addition, the size of the image sensor is increasing to realize high resolution and high quality. However, when the size of the image sensor is increased, a total track length (TTL) of the optical system including the plurality of lenses also increases, and thus there is a problem in that the thickness of the camera and the mobile terminal including the optical system also increases.

Therefore, a new optical system capable of solving the above problems is required.

### DISCLOSURE

### Technical Problem

An embodiment provides an optical system with improved optical properties. An embodiment provides an optical system having excellent optical performance on the center and periphery portions of the angle of field of view. An embodiment provides an optical system capable of having a slim structure.

### Technical Solution

An optical system according to an embodiment of the invention includes first to seventh lenses disposed along an optical axis from an object side to a sensor side, the first lens has positive (+) refractive power on the optical axis, and the second lens has a negative (−) refractive power on the optical axis, the seventh lens has a negative (−) refractive power on the optical axis, an object-side surface of the first lens has a convex shape on the optical axis, a sensor-side surface of first lens is bonded to the second lens, a sensor-side surface of the seventh lens has a largest effective aperture among the first to seventh lenses, and a distance in the optical axis from an apex of the object-side surface of the first lens to an image surface of an image sensor is TTL, ½ of a maximum diagonal length of the image sensor is ImgH, a refractive index of the first lens is n1, a refractive index of the second lens is n2, and the following equations may satisfy: 0.4<TTL/ImgH<3 and 0.05<(n2)−(n1)<0.25.

According to an embodiment of the invention, a refractive index of the third lens is n3, and the refractive index of each of the first, second, and third lenses may satisfy the following equations: 1.45<n1<1.65, 1.55<n2<1.8, and 1.6<n3. The Abbe numbers of the first and second lenses are v1 and v2, and may satisfy the following equation: 10<(v1)−(v2)<50.

According to an embodiment of the invention, a thickness of the first lens at the optical axis is L1_CT, a thickness of the third lens at the optical axis is L3_CT, and the largest effective aperture among the effective apertures of the object-side surfaces and the sensor-side surfaces of the first to seventh lenses is CA_Max, and the smallest effective aperture among the effective apertures of the object-side surface and the sensor-side surface of the first to seventh lenses is CA_Min, and at least one of the following equations may satisfy: 2<L1_CT/L3_CT<5 and 1<CA_Max/CA_min<5. The sensor-side surface of the second lens may have a minimum effective aperture among the effective apertures of the first to seventh lenses.

According to an embodiment of the invention, an average value of the effective apertures of the object-side surface and the sensor-side surface of the seventh lens is AVR_CA_L7, and an average value of the effective apertures of the object-side surface and sensor-side surfaces of the second lens is AVR_CA_L2, and the second and seventh lenses may satisfy the following equation:

$$2 < AVR\_CA \_L7 / AVR\_CA \_L2 < 4 .$$

According to an embodiment of the invention, the object-side surface of the sixth lens may have a convex shape on the optical axis, the sensor-side surface may have a convex shape on the optical axis, and the sixth lens may have positive refractive power. The object-side surface of the seventh lens may have a concave shape on the optical axis, and the sensor-side surface of the seventh lens may have a concave shape on the optical axis.

According to an embodiment of the invention, the thickness of the first lens at the optical axis is L1_CT, the thickness of the seventh lens at the optical axis is L7_CT, a distance (mm) in the optical axis between the second lens and the third lens is d23_CT, a distance (mm) in the optical axis between the sensor-side surface of the sixth lens and the object-side surface of the seventh lens is d67_CT, and the first and second lenses and the sixth and seventh lenses may satisfy the following equations: 1<L1_CT/L7_CT<5 and 1<d67_CT/d23_CT<4.

According to an embodiment of the invention, the sensor-side surface of the seventh lens has an inflection point, the inflection point is located at a position of 30% or more of a distance from the optical axis to an end of an effective region of the seventh lens, and the following equation may satisfy: 0.5<L7S2_max_sag to Sensor<2 (L7S2_max_sag to Sensor is a distance in the optical axis direction from the maximum Sag value of the sensor-side surface of the seventh lens to the image sensor.).

An optical system according to an embodiment of the invention includes a first lens group having at least two lenses from an object side to a sensor side; and a second lens group disposed on a sensor side of the second lens group and having more lenses than the number of lenses of the first lens group, a total number of lenses included in the first and second lens groups is 7 or less, a maximum distance between the first and second lens groups is dG12_Max, a minimum distance between the first and second lens groups is dG12_Min, a distance in the optical axis between the two lenses within the first lens group is d12_CT, an optical axis distance between the first and second lens groups is dG12_CT, and the following equations may satisfy: dG12_Max=(dG12_CT/d12_CT) and dG12_Min<(dG12_CT/d12_CT).

According to an embodiment of the invention, the first lens group includes an object-side first lens and a sensor-side second lens, a distance in the optical axis between the first lens and the second lens is d12_CT, a distance in the optical axis direction between an end of an effective region between the first lens and the second lens is d12_ET, and the following equation may satisfy:

$$0.01 > d12\_CT - d12\_ET .$$

According to an embodiment of the invention, an effective aperture size of a sensor-side surface closest to the second lens group among the lens surfaces of the first lens group is minimum, and the effective aperture size of the sensor-side surface closest to the image sensor among the lens surfaces of the second lens group is maximum, a distance in the optical axis from the apex of the object-side surface of the first lens to the image surface of the image sensor is TTL, and the maximum diagonal length of the image sensor is IH, and the following equation may satisfy: 0.6<TTL/IH<0.8. The absolute value of the focal length of each of the first and second lens groups may be larger for the second lens group.

According to an embodiment of the invention, the first lens group includes first and second lenses disposed along the optical axis in the direction from the object side to the sensor side, and the second lens group includes the third to seven lenses disposed along the optical axis in the direction from the object side to the sensor side, wherein the sensor-side surface of the first lens and the object-side surface of the second lens are bonded, and the sensor-side surface of the second lens may have the minimum effective aperture.

According to an embodiment of the invention, an optical axis distance between the second lens and the third lens is d23_CT, an optical axis distance between the sensor-side surface of the sixth lens and the object-side surface of the seventh lens is d67_CT, and the optical axis distance between the sixth and seventh lenses and the optical axis distance between the second and third lenses may satisfy the following equation: 1<d67_CT/d34_CT<4.

According to an embodiment of the invention, the second lens has a negative refractive power different from the refractive power of the first lens, a refractive index higher than the refractive index of the first lens, and an Abbe number lower than the Abbe number of the first lens, the refractive indices of the first and second lenses are n1 and n2, and the following equation may satisfy: 0.05<(n2)−(n1)<0.25. The refractive indices of the first and second lenses are n1 and n2, and the Abbe numbers of the first and second lenses are v1 and v2, and the following equations may satisfy: 1.45<n1<1.65, 1.55<n2<1.8 and 10<(v1)−(v2)<50.

According to an embodiment of the invention, the thickness of the first lens group in the optical axis may be equal to the sum of the thicknesses of the at least two lenses. The thickness at the ends of the effective region of the first lens group may be equal to the distance between the ends of the effective regions of the at least two lenses. The first lens group may consist of two lenses bonded together, and the second lens group may consist of five lenses.

A camera module according to an embodiment of the invention includes an image sensor; and a filter between the image sensor and the last lens of the optical system, wherein the optical system includes any one of the optical systems disclosed above, the total focal length of the optical system is F, and an entrance pupil diameter of the optical system is EPD, and the following equation may satisfy: 1≤F/EPD<5.

### Advantageous Effects

The optical system and the camera module according to the embodiment may have improved optical properties. In detail, the optical system may have improved aberration characteristics, resolution, etc. as a plurality of lenses are formed with a set surface shape, refractive power, thickness, and distance.

The optical system according to an embodiment of the invention can improve aberration and control incident light rays by providing a cemented lens to the object-side lens group. The optical system and the camera module according to the embodiment may have improved distortion and aberration control characteristics, and may have good optical performance even in the center and periphery portions of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a block diagram of an optical system according to a first embodiment.

FIG. 2 is a diagram illustrating a relationship between an image sensor, an n-th lens, and an n-lth lens in the optical system of FIG. 1.

FIG. 3 shows data on the aspheric coefficient of each lens surface in the optical system of FIG. 1.

FIG. 4 shows data on the distances between two adjacent lenses in the optical system of FIG. 1.

FIG. 5 is a graph of the diffraction MTF of the optical system of FIG. 1.

FIG. 6 is a graph showing the aberration characteristics of the optical system of FIG. 1.

FIG. 7 is a graph showing the height of the optical axis direction of the object-side surface and the sensor-side surface of the last n-th lens in the optical system of FIG. 1.

FIG. 8 is a configuration diagram of an optical system according to the second embodiment.

FIG. 9 is an explanatory diagram showing the relationship between the image sensor, the n-th lens, and the n−1-th lens in the optical system of FIG. 8.

FIG. 10 shows data on the aspheric coefficient of each lens surface in the optical system of FIG. 8.

FIG. 11 shows data on the distance between two adjacent lenses in the optical system of FIG. 8.

FIG. 12 is a graph of the diffraction MTF of the optical system of FIG. 8.

FIG. 13 is a graph showing the aberration characteristics of the optical system of FIG. 8.

FIG. 14 is a graph showing the height of the object-side surface and the sensor-side surface in the optical axis direction of the last n-th lens in the optical system of FIG. 8.

FIG. 15 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may mean the surface of the lens that faces the object side with respect to the optical axis OA, and “sensor-side surface” may mean the surface of the lens that faces the imaging surface (image sensor) with respect to the optical axis. The expression that one surface of the lens is convex may mean a convex shape on the optical axis or paraxial region, and the expression that one surface of the lens is the concave may mean a concave shape on the optical axis or paraxial region. The curvature radius, the center thickness, the distance between lenses, and TTL described in the table for lens data may mean values on the optical axis. The vertical direction may mean a direction perpendicular to the optical axis, and the end of the lens or the lens surface may mean the end of the effective region of the lens through which the incident light passes. The effective diameter of the lens surface may have a measurement error of up to ±0.4 mm depending on the measurement method. The paraxial region means a very narrow region near the optical axis, and is a region in which the distance from which the light beam falls from the optical axis OA is almost zero. Hereinafter, the concave or convex shape of the lens surface will be described as an optical axis, and may also include a paraxial region.

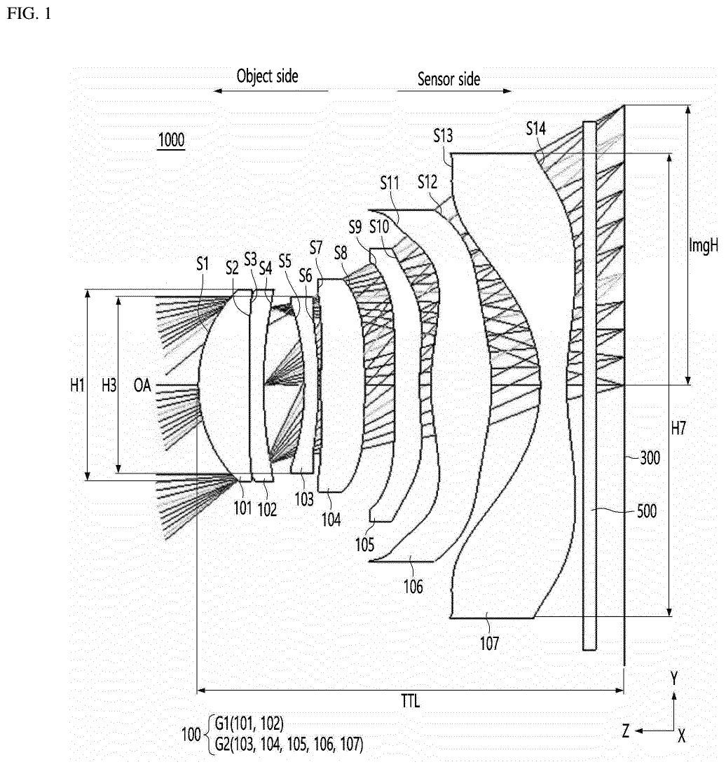

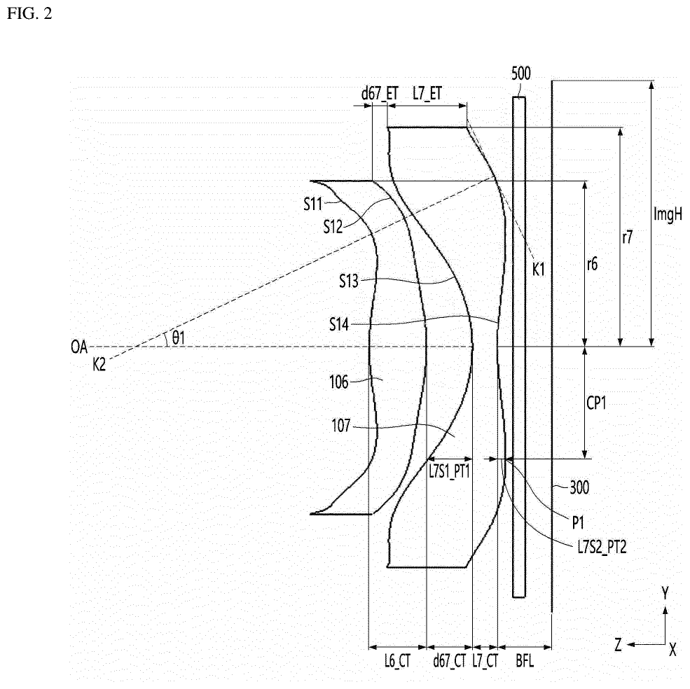

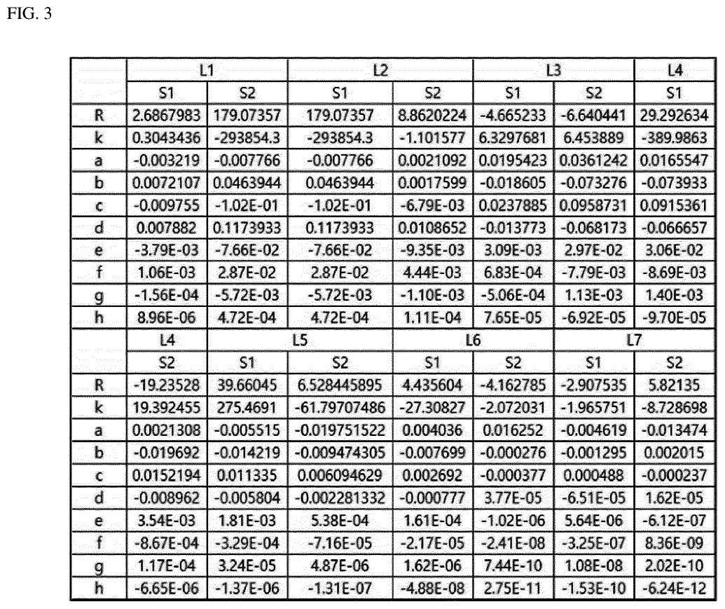

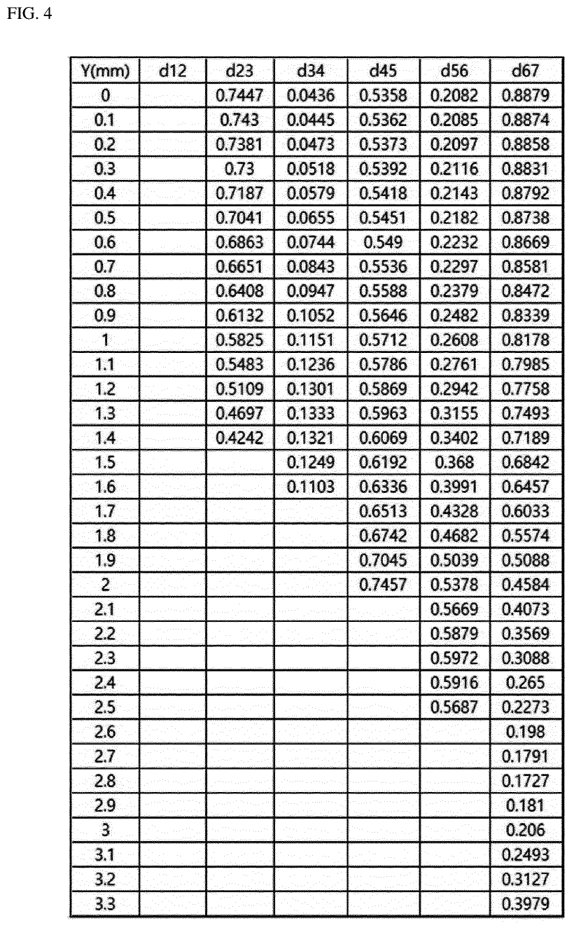

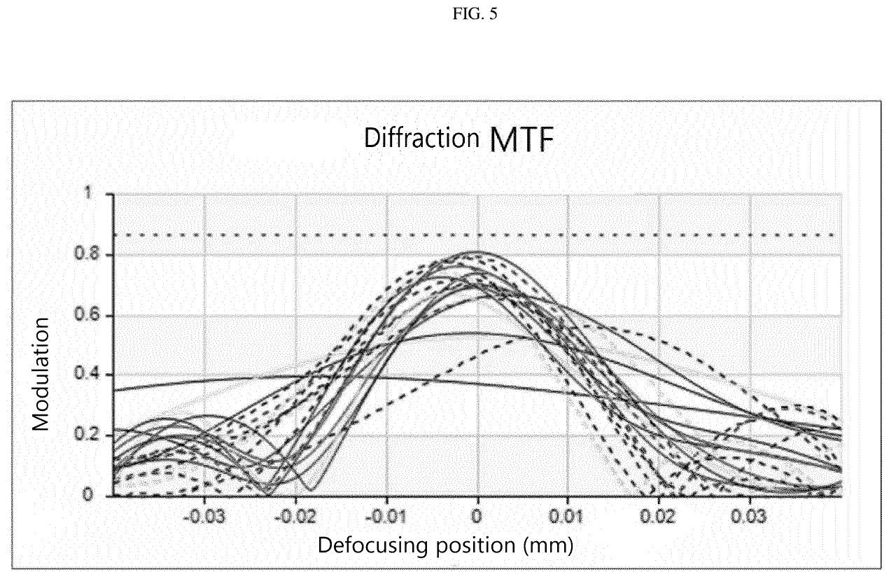

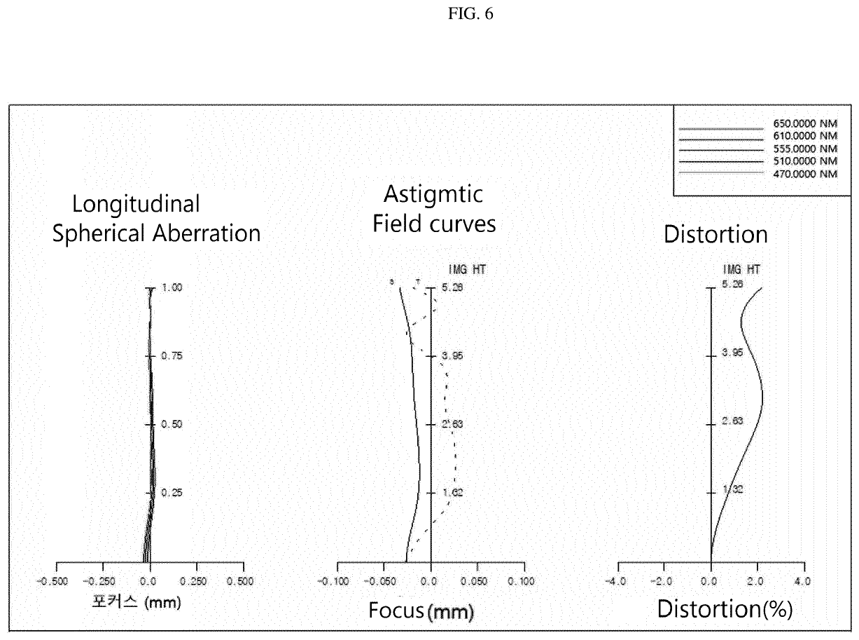

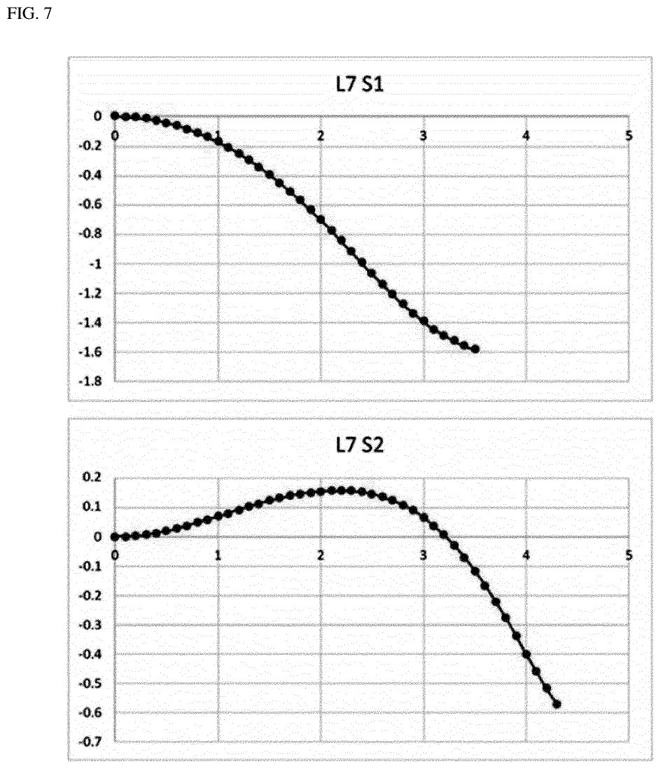

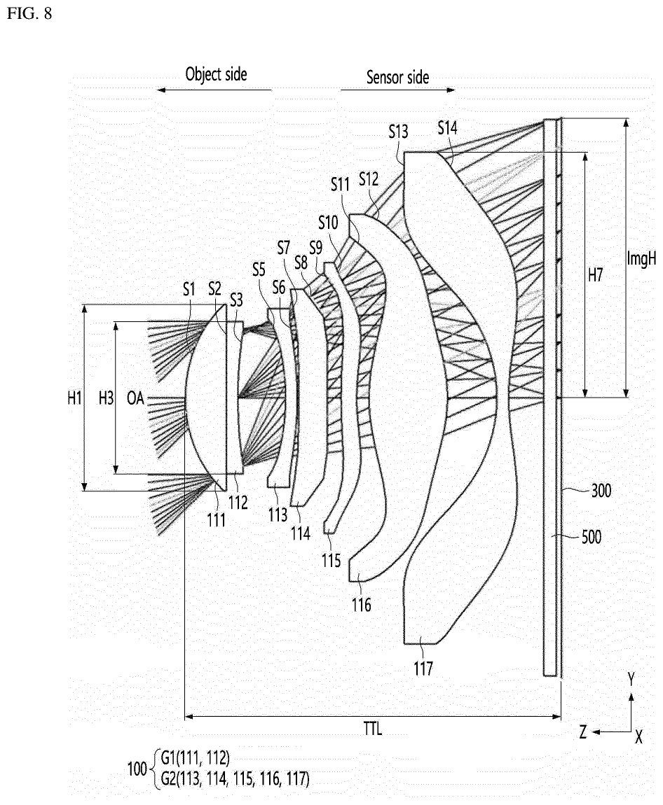

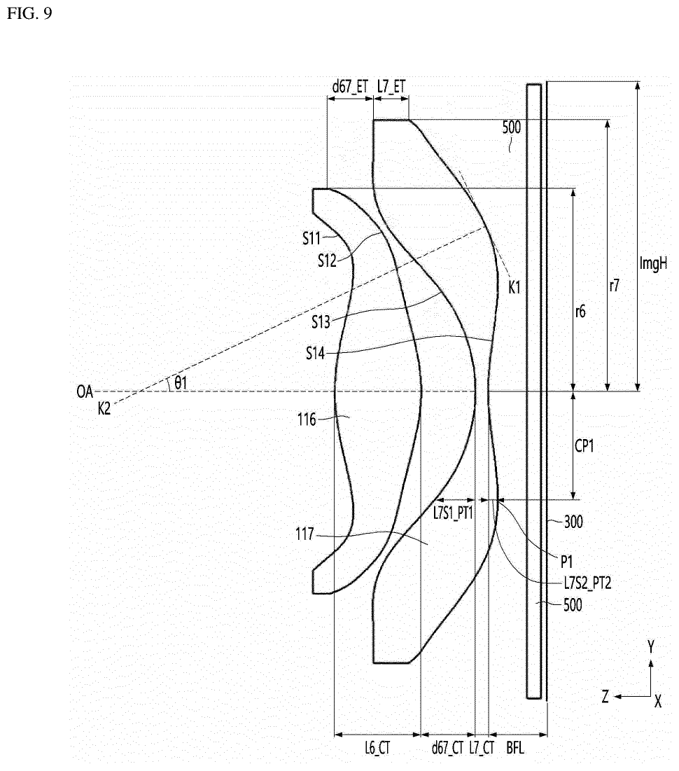

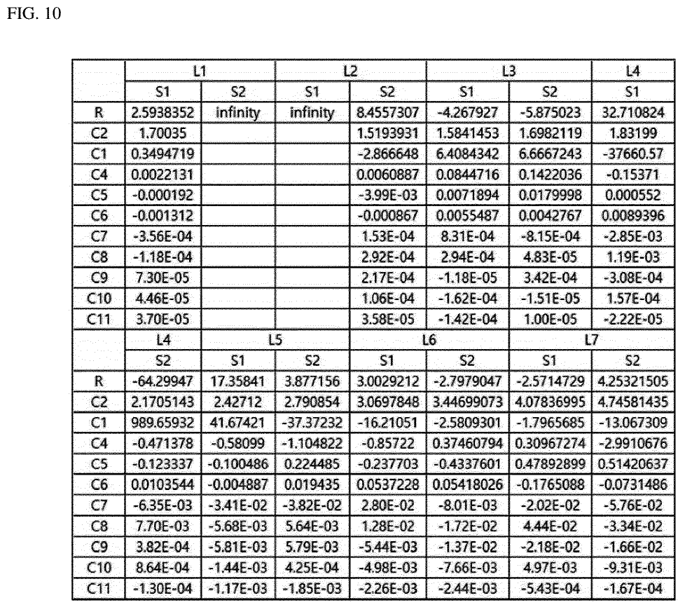

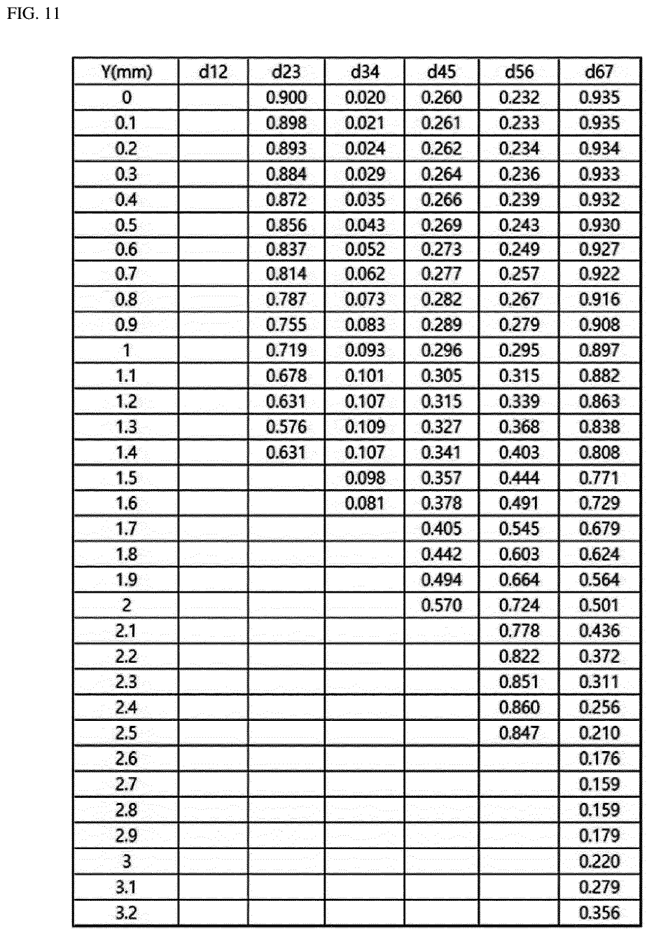

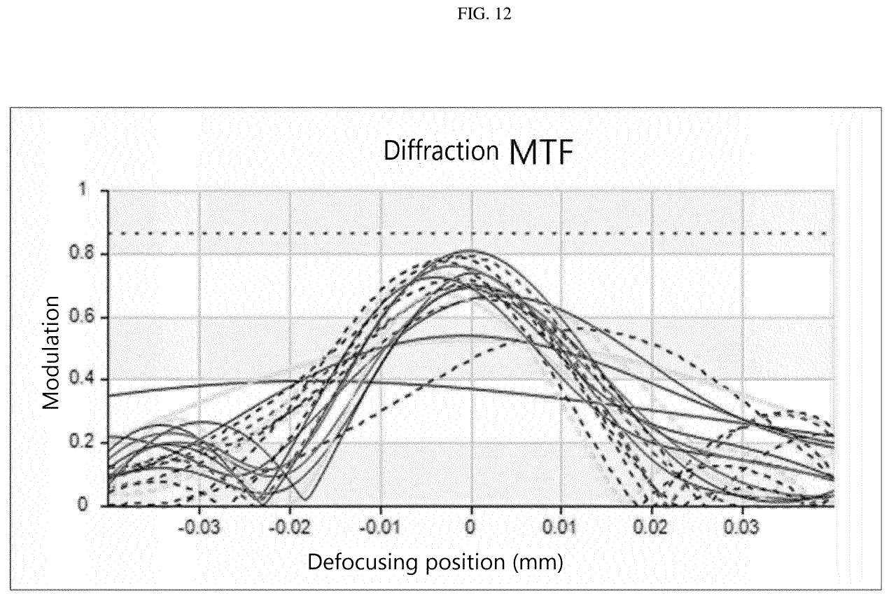

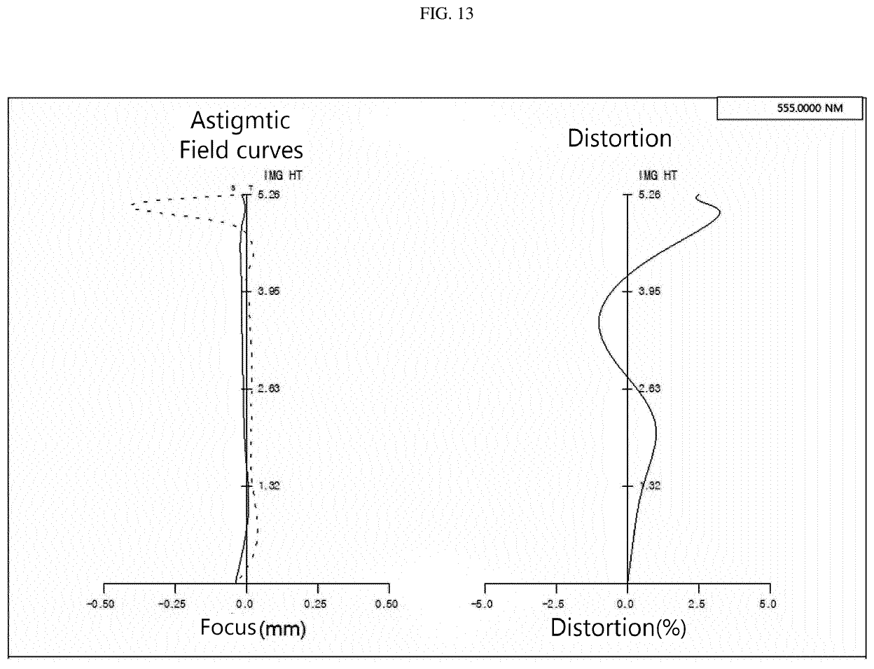

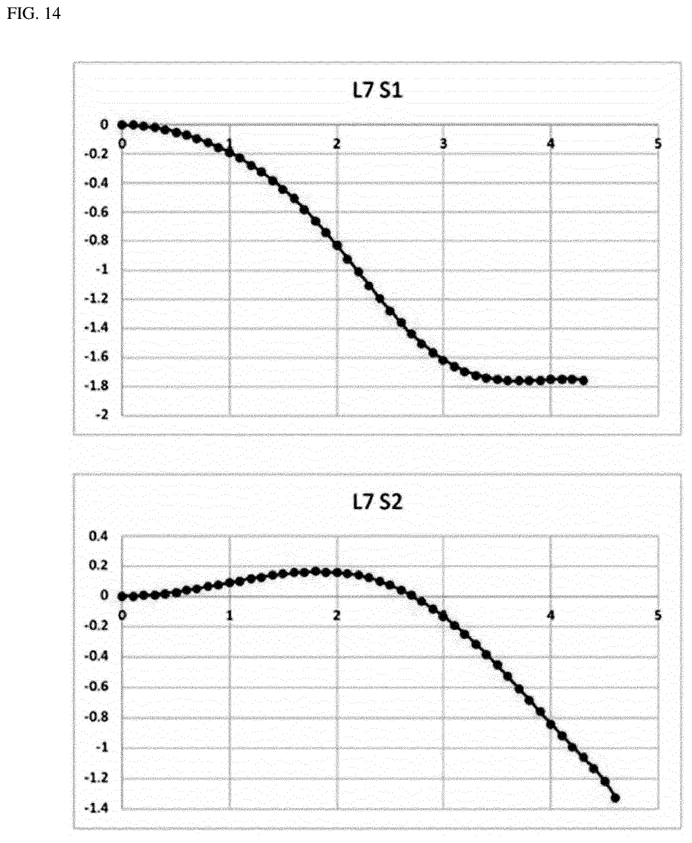

FIG. 1 is a block diagram of an optical system according to a first embodiment, FIG. 2 is a diagram illustrating a relationship between an image sensor, an n-th lens, and an n-lth lens in the optical system of FIG. 1, FIG. 3 shows data on the aspheric coefficient of each lens surface in the optical system of FIG. 1, FIG. 4 shows data on the distances between two adjacent lenses in the optical system of FIG. 1, FIG. 5 is a graph of the diffraction MTF of the optical system of FIG. 1, FIG. 6 is a graph showing the aberration characteristics of the optical system of FIG. 1, FIG. 7(A)(B) is a graph showing the height of the optical axis direction of the object-side surface and the sensor-side surface of the last n-th lens in the optical system of FIG. 1, FIG. 8 is a configuration diagram of an optical system according to the second embodiment, FIG. 9 is an explanatory diagram showing the relationship between the image sensor, the n-th lens, and the n−1-th lens in the optical system of FIG. 8, FIG. 10 shows data on the aspheric coefficient of each lens surface in the optical system of FIG. 8, FIG. 11 shows data on the distance between two adjacent lenses in the optical system of FIG. 8, FIG. 12 is a graph of the diffraction MTF of the optical system of FIG. 8, FIG. 13 is a graph showing the aberration characteristics of the optical system of FIG. 8, and FIG. 14(A)(B) is a graph showing the height of the object-side surface and the sensor-side surface in the optical axis direction of the last n-th lens in the optical system of FIG. 8.

Referring to FIGS. 1 and 8, an optical system 1000 according to the embodiment may include a plurality of lens groups G1 and G2 on the image sensor 300. In detail, each of the plurality of lens groups G1 and G2 includes at least one lens. For example, the optical system 1000 may include a first lens group G1 and a second lens group G2 sequentially arranged along the optical axis OA from the object side toward the image sensor 300.

The first lens group G1 may include at least one lens. The first lens group G1 may include three or less lenses or two or less lenses. For example, the first lens group G1 may include two lenses. The second lens group G2 may include more than twice as many lenses as the number of lenses of the first lens group G1. The second lens group G2 may include six or less lenses. The number of lenses of the second lens group G2 may be three or more and five or less different than the number of lenses of the first lens group G1. For example, the second lens group G2 may include five lenses.

The first lens group G1 may have positive (+) refractive power. The second lens group G2 may have a different negative refractive power than the first lens group G1. The first lens group G1 and the second lens group G2 may have different focal lengths. Since the first lens group G1 and the second lens group G2 have opposite refractive powers, the focal length (f_G2) of the second lens group G2 has a negative sign, The focal length of the first lens group G1 may have a positive (+) sign.

When expressed as an absolute value, the focal length of the first lens group G1 may be smaller than the focal distance of the second lens group G2. For example, the absolute value of the focal length of the first lens group G1 may be 10 times or more the absolute value of the focal length of the second lens group G2, for example, in the range of 10 to 20 times or 12 to 17 times.

Accordingly, the optical system 1000 according to the embodiment can have improved aberration control characteristics such as chromatic aberration and distortion aberration by controlling the refractive power and focal length of each lens group, and may have good optical performance in the center and periphery portions of the field of view (FOV).

In the optical axis OA, the first lens group G1 and the second lens group G2 may have a set distance. The distance between the first lens group G1 and the second lens group G2 in the optical axis OA is an optical axis distance, and may be the optical axis distance between the sensor-side surface of the lens closest to the sensor side among the lenses in the first lens group G1 and the object-side surface of the lens closest to the object side among the lenses in the second lens group G2. The optical axis distance between the first lens group G1 and the second lens group G2 may be greater than the center thickness of at least one of the lenses of the first lens group G1, for example, 0.5 mm or more, and may be smaller than the optical axis distance of the first lens group G1. The optical axis distance between the first lens group G1 and the second lens group G2 may be smaller than the center thickness of the thickest lens among the lenses of the first lens group G1, and may be smaller than the center thickness of the thickest lens among the lenses of the second lens group G2. The optical axis distance between the first lens group G1 and the second lens group G2 may be 35% or less of the optical axis distance of the second lens group G2, for example, in the range of 20% to 35%. Accordingly, the optical system 1000 can have good optical performance not only in the center portion of the field of view (FOV) but also in the periphery portion, and can improve chromatic aberration and distortion aberration. Here, the optical axis distance of the first lens group G1 is the optical axis distance between the object-side surface of the lens closest to the object side of the first lens group G1 and the sensor-side surface of the lens closest to the image sensor. The optical axis distance of the second lens group G2 is the optical axis distance between the object-side surface of the lens closest to the object side of the second lens group G2 and the sensor-side surface of the lens closest to the image sensor 300.

The optical system 1000 may include two or less lenses with an Abbe number of 45 or more, for example, in the range of 45 to 70. The optical system 1000 may include three or less lenses with a refractive index of 1.5 or more, for example, in the range of 1.6 to 1.7.

The first lens group G1 may include a cemented lens. The first lens group G1 may be composed of lenses in which two sheets having different center thicknesses are bonded. The thickness of the first lens group G1 in the optical axis may be equal to the sum of the thicknesses of the at least two lenses. The distance in the optical axis direction between the object-side surface and the sensor-side surface at the end of the effective region of the first lens group G1 may be equal to the distance between the ends of the effective regions on the object side and the sensor side of the at least two lenses. In the cemented lens, the Abbe number of the object-side lens may be higher than the Abbe number of the sensor-side lens, and the refractive index of the object-side lens may be lower than the refractive index of the sensor-side lens. In the cemented lens, the center thickness of the object-side lens may be more than twice the center thickness of the sensor-side lens, and the focal length of the object-side lens may be smaller than the absolute value of the focal length of the sensor-side lens. By providing a cemented lens in the first lens group G1, the optical system 1000 can improve the aberration characteristics of the optical system, control incident light, and provide a slim optical system.

The optical system 1000 may include the first lens group G1 and the second lens group G2 sequentially arranged from the object side toward the image sensor 300. The optical system 1000 may include eight or less lenses. The first lens group G1 refracts the light incident through the object side to collect it, and the second lens group G2 may refract the light emitted through the first lens group G1 to be diffused to the center and periphery portions of the image sensor 300. The first lens group G1 may have the same number of lenses with positive (+) refractive power and lenses with negative (−) refractive power. In the second lens group G2, the number of lenses with positive (+) refractive power may be smaller than the number of lenses with negative (−) refractive power. The lens surface (e.g., S3) of the first lens group G1 and the lens surface (e.g., S5) of the second lens group G2 that face each other may have a concave shape on the optical axis. Among the distances between the lenses of the first and second lens groups G1 and G2, the optical axis distance between the first and second lens groups G1 and G2 may have the largest distance except for the maximum optical axis distance between the lenses of the second lens group G2.

The sum of surfaces in which the object side is convex and the sensor side is concave on the optical axis OA or paraxial region of each lens of the first lens group G1 may be more than 70% of the lens surface of the first lens group G1. The sum of the concave surface on the object side and the convex surface on the sensor side on the optical axis OA or paraxial region of each lens of the second lens group G2 may be more than 50% of the lens surface of the second lens group G2. The first lens group G1 includes an object-side lens with positive (+) refractive power and a sensor-side lens with negative (−) refractive power, and the refractive index of the object-side lens may be lower than the refractive index of the sensor-side lens. Accordingly, the aberration characteristics of the optical system 1000 can be improved. The optical system 1000 according to the embodiment may further include a reflective member (not shown) for changing the path of light on the object side of the first lens group G1. The reflective member may be implemented as a prism that reflects incident light in the direction of the lenses.

Referring to FIGS. 1 and 2, the optical system 1000 according to the first embodiment may include a first lens 101, a second lens 102, a third lens 103, a fourth lens 104, a fifth lens 105, a sixth lens 106, and a seventh lens 107. The first to seventh lenses 101 to 107 may be sequentially arranged along the optical axis OA of the optical system 1000. Light corresponding to object information may pass through the first lens 101, the second lens 102, the third lens 103, the fourth lens 104, the fifth lens 105, the sixth lens 106, and the seventh lens 107 to be incident on the image sensor 300.

Each of the plurality of lenses 100 may include an effective region and a non-effective region. The effective region may be a region through which light incident on each of the lenses 100 passes. That is, the effective region may be an effective region in which the incident light is refracted to implement optical characteristics. The non-effective region may be arranged around the effective region. The non-effective region may be a region where effective light does not enter the plurality of lenses 100. That is, the non-effective region may be a region unrelated to the optical characteristics. Additionally, the end of the non-effective region may be a region fixed to a barrel (not shown) that accommodates the lens.

The optical system 1000 may include an image sensor 300. The image sensor 300 can detect light and convert it into an electrical signal. The image sensor 300 may detect light that sequentially passes through the plurality of lenses 100. The image sensor 300 may include an element capable of detecting incident light, such as a charge coupled device (CCD) or a complementary metal oxide semiconductor (CMOS). The optical system 1000 may include a filter 500. The filter 500 may be disposed between the second lens group G2 and the image sensor 300.

The filter 500 may be disposed between the image sensor 300 and a lens closest to the sensor among the plurality of lenses 100. For example, when the optical system 100 is a seven-sheet lens, the filter 500 may be disposed between the seventh lens 111 and the image sensor 300.

The filter 500 may include at least one of an infrared filter or an optical filter of a cover glass. The filter 500 may pass light in a set wavelength band and filter light in a different wavelength band. When the filter 500 includes an infrared filter, radiant heat emitted from external light can be blocked from being transmitted to the image sensor 300. Additionally, the filter 500 can transmit visible light and reflect infrared rays.

The optical system 1000 according to the embodiment may include an aperture stop (not shown). The aperture stop can control the amount of light incident on the optical system 1000. The aperture stop can placed at a set position. For example, the aperture stop may be disposed around the object-side surface or sensor-side surface of the lens closest to the object side. The aperture stop may be disposed between two adjacent lenses among the lenses in the first lens group G1. For example, the aperture stop may be located between the second lens 102 and the third lens 103. The aperture stop may be disposed around the sensor-side surface of the cemented lens. The aperture stop may be located between the cemented lens and the third lens 103. Alternatively, at least one lens selected from among the plurality of lenses 100 may function as an aperture stop. In detail, the object-side surface or sensor-side surface of one lens selected from among the lenses 100 may function as an aperture stop to control the amount of light. For example, the object-side surface or sensor-side surface of the cemented lens, the sensor-side surface S3 of the second lens 102, or the object-side surface S4 of the third lens 103 serves as an aperture stop.

The optical system 1000 according to the first embodiment of the invention may be composed of the first lens 101 to the seventh lens 107. The first and second lenses 101 and 102 may be the first lens group G1 or the sensor-side lens group, and the third to seventh lenses 103 to 107 may be the second lens group G2 or the object-side lens group.

The first lens 101 is the lens closest to the object in the first lens group G1. The first lens 101 may have positive (+) refractive power on the optical axis OA. The first lens 101 may include plastic or glass. Preferably, the first lens 101 may be made of plastic. The first lens 101 may include a first surface S1 defined as an object-side surface and a second surface S2 defined as a sensor-side surface. The first lens 101 may have a meniscus shape that is convex toward the object. To explain further, the first surface S1 may have a convex shape on the optical axis OA, and the second surface S2 may have a concave shape on the optical axis OA. Differently, among the first and second surfaces S1 and S2, the second surface S2 may have a convex shape on the optical axis OA. That is, the first lens 101 may have a shape in which both sides are convex on the optical axis OA. At least one or both of the first surface S1 and the second surface S2 may be aspherical. The aspheric coefficients of the first and second surfaces S1 and S2 are provided as shown in FIG. 3, where L1 is the first lens 101 and S1/S2 represent the first/second surfaces of L1.

The second lens 102 may be disposed between the first lens 101 and the third lens 103. The second lens 102 may have negative refractive power on the optical axis OA. The second lens 102 may include plastic or glass. For example, the second lens 102 may be made of plastic. The second lens 102 may include a second surface S2 defined as an object-side surface and a third surface S3 defined as a sensor-side surface. The second surface S2 may have a convex shape on the optical axis OA, and the third surface S3 may have a concave shape on the optical axis. Here, the first lens 101 and the second lens 102 may be cemented lens. The sensor-side surface of the first lens 101 and the object-side surface of the second lens 102 are bonded to each other and may be the second surface S2. The second surface S2 is a sensor-side surface of the first lens 101, and may have a concave shape on the optical axis OA with respect to the first lens 101, and may have a convex shape with respect to the second lens 102. Differently, among the second and third surfaces S2 and S3, the second surface S2 may have a concave shape on the optical axis OA. The third surface S3 may have a convex shape on the optical axis OA.

The effective aperture of the sensor-side surface of the first lens 101 and the object-side surface of the second lens 102 may be the effective aperture of the bonded second surface S2. The size of the effective aperture H1 of the first surface S1 of the first lens 101 may be larger than the size of the effective aperture H1 of the second surface S2 and the third surface S3. At least one or both of the second surface S2 and the third surface S3 may be aspherical. The aspherical coefficients of the second and third surfaces S2 and S3 are provided as shown in FIG. 3, where L2 is the second lens 102 and S1/S2 represent the first/second surfaces of L2. S1 of L2 and S2 of L1 are bond surfaces and may have the same aspheric coefficient.

Among the first and second lenses 101 and 102, the absolute value of the focal length of the second lens 102 may be greater. The first and second lenses 101 and 102 may have different center thicknesses CT. In detail, among the first and second lenses 101 and 102, the center thickness of the first lens 101 may be greater than the center thickness of the second lens 103. Among the first and second lenses 101 and 102, the second lens 102 may have a higher refractive index than the first lens 101. The refractive index of the second lens 102 may be greater than 1.6, and the refractive index of the first lens 101 may be less than 1.6. The Abbe number of the second lens 102 may be smaller than that of the first lens 101, for example, may be 15 or more smaller than the Abbe number of the first lens 101. The aberration can be improved by using the difference in refractive index and Abbe number of the lenses of the first lens group G1.

The size (CA: clear aperture) of the effective aperture of the lens surfaces in the first and second lenses 101 and 102, the sensor-side surface of the second lens 102 may be the smallest, and the object-side surface of the first lens 101 may be the largest. In detail, the size of the effective aperture of the sensor-side third surface S3 of the second lens 102 may be the smallest among the first to third surfaces S1, S2, and S3. In addition, the size of the effective aperture of the sensor-side third surface S3 of the second lens 102 may be the smallest of the object-side surfaces and the sensor-side surfaces of the first to seventh lenses 101 to 107. Accordingly, the optical system 1000 can control incident light to improve resolution and chromatic aberration control characteristics, and can improve vignetting characteristics of the optical system 1000.

The third lens 103 is the lens closest to the object within the second lens group G2. The third lens 103 may have positive (+) or negative (−) refractive power on the optical axis OA. The third lens 103 may have negative (−) refractive power. The third lens 103 may include plastic or glass. For example, the third lens 103 may be made of plastic. The third lens 103 may include a fifth surface S5 defined as an object-side surface and a sixth surface S6 defined as a sensor-side surface. The third lens 103 may have a meniscus shape that is convex from the optical axis OA toward the sensor. To explain further, the fifth surface S5 may have a concave shape on the optical axis OA, and the sixth surface S6 may have a convex shape on the optical axis OA. Alternatively, the third lens 103 may have a shape that is concave at both sides or convex at both sides on the optical axis OA. At least one of the object-side surface or the sensor-side surface of the third lens 103 may have an inflection point. The sixth surface S6 may have an inflection point, and the fifth surface S5 may have no inflection point. As another example, the sixth surface S6 may be provided without an inflection point. At least one or both of the fifth surface S5 and the sixth surface S6 may be aspherical. The aspheric coefficients of the fifth and sixth surfaces S5 and S6 are provided as shown in FIG. 3, where L3 is the third lens 103, and S1/S2 represent first surface/second surface or fifth surface/sixth surface of L3.

The fourth lens 104 may have positive (+) or negative (−) refractive power on the optical axis OA. The fourth lens 104 may have positive refractive power. The fourth lens 104 may include plastic or glass. For example, the fourth lens 104 may be made of plastic. The fourth lens 104 may include a seventh surface S7 defined as an object-side surface and an eighth surface S8 defined as a sensor-side surface. The fourth lens 104 may have a shape in which both sides are convex on the optical axis OA. To explain further, the seventh surface S7 may have a convex shape on the optical axis OA, and the eighth surface S8 may have a convex shape on the optical axis OA. Alternatively, the fourth lens 104 may have a meniscus shape convex toward the object or a meniscus shape convex toward the sensor. Alternatively, the fourth lens 104 may have a concave shape on both sides of the optical axis OA. At least one of the object-side surface or the sensor-side surface of the fourth lens 104 may have an inflection point. The seventh surface S7 may have an inflection point, and the eighth surface S8 may have no inflection point. As another example, the seventh surface S7 may be provided without an inflection point. At least one of the seventh surface S7 and the eighth surface S8 may be an aspherical surface. For example, both the seventh surface S7 and the eighth surface S8 may be aspherical. The aspherical coefficients of the seventh and eighth surfaces S7 and S8 are provided as shown in FIG. 3, where L4 is the fourth lens 104, and S1/S2 represents the first surface/second surface or seventh surface/eighth surface of L4.

The fifth lens 105 may have positive (+) or negative (−) refractive power on the optical axis OA. The fifth lens 105 may have negative refractive power. The fifth lens 105 may include plastic or glass. For example, the fifth lens 105 may be made of plastic. The fifth lens 105 may include a ninth surface S9 defined as an object-side surface and a tenth surface S10 defined as a sensor-side surface. The fifth lens 105 may have a meniscus shape that is convex toward the object. Preferably, the ninth surface S9 may have a convex shape from the optical axis OA toward the object, and the tenth surface S10 may have a concave shape from the optical axis OA. Alternatively, the fifth lens 105 may have a meniscus shape that is convex toward the sensor. To explain further, the ninth surface S9 may have a concave shape on the optical axis OA, and the tenth surface S10 may have a convex shape on the optical axis OA. Alternatively, the fifth lens 105 may have a concave or convex shape at both sides on the optical axis OA. At least one of the ninth surface S9 and the tenth surface S10 may be an aspherical surface. For example, both the ninth surface S9 and the tenth surface S10 may be aspherical. The aspherical coefficients of the ninth and tenth surfaces S9 and S10 are provided as shown in FIG. 3, where L5 is the fifth lens 105, and S1/S2 represent the first surface/second surface or ninth surface/tenth surface of L5.

The sixth lens 106 may have positive (+) refractive power on the optical axis OA. The sixth lens 106 may include plastic or glass. For example, the sixth lens 106 may be made of plastic. The sixth lens 106 may include an eleventh surface S11 defined as an object-side surface and a twelfth surface S12 defined as a sensor-side surface. The sixth lens 106 may have a shape in which both sides are convex on the optical axis OA. The eleventh surface S11 may have a convex shape on the optical axis OA, and the twelfth surface S12 may have a convex shape on the optical axis OA. At least one of the eleventh surface S11 and the twelfth surface S12 may have an inflection point. The eleventh surface S11 may have an inflection point formed at a predetermined position, and the twelfth surface S12 may have an inflection point or be provided without an inflection point. For example, the inflection point of the eleventh surface S11 may be located at a position greater than 50% of the distance (i.e., effective radius) from the optical axis OA to the end of the effective region, for example, in the range of 50% to 70%. In FIG. 2, the effective radius r6 of the twelfth surface S12 may be smaller than the effective radius r7 of the fourteenth surface S14, for example, 85% or less of the effective radius r7. At least one of the eleventh surface S11 and the twelfth surface S12 may be an aspherical surface. For example, both the eleventh surface S11 and the twelfth surface S12 may be aspherical. The aspheric coefficients of the eleventh and twelfth surfaces S11 and S12 are provided as shown in FIG. 3, where L6 is the sixth lens 106, and S1/S2 represent the first/second surfaces or eleventh/twelfth surfaces of L6.

The seventh lens 107 may have negative refractive power on the optical axis OA. The seventh lens 107 may include plastic or glass. For example, the seventh lens 107 may be made of plastic. The seventh lens 107 may include a thirteenth surface S13 defined as an object-side surface and a fourteenth surface S14 defined as a sensor-side surface. The seventh lens 107 may have a concave shape at both sides on the optical axis OA. The thirteenth surface S13 may have a concave shape on the optical axis OA, and the fourteenth surface S14 may have a concave shape on the optical axis OA. At least one of the thirteenth surface S13 and the fourteenth surface S14 may have an inflection point. For example, both the thirteenth surface S13 and the fourteenth surface S14 may have inflection points. The inflection point of the fourteenth surface S14 may be located at a position greater than 40% of the distance r7 from the optical axis OA to the end of the effective region, for example, in the range of 40% to 60%. At least one of the thirteenth surface S13 and the fourteenth surface S14 may be an aspherical surface. For example, both the thirteenth surface S13 and the fourteenth surface S14 may be aspherical. The aspherical coefficients of the thirteenth and fourteenth surfaces S13 and S14 are provided as shown in FIG. 3, where L7 is the seventh lens 107, and S1/S2 represent the first/second surfaces or thirteenth/fourteenth surfaces of L7.

Among the third to seventh lenses 103 to 107, at least one of the object-side and sensor-side surfaces of the second lens 102 may have the smallest effective aperture (CA: clear aperture), and at least one of the object-side and the sensor-side surfaces of the seventh lens 107 may be the largest. In detail, the size of the effective aperture of the object-side third surface S3 of the second lens 102 may be the smallest among the object-side surface and sensor-side surfaces of the third to seventh lenses 103 to 107. The size of the effective aperture of the sensor-side fourteenth surface S14 of the seventh lens 107 may be the largest among the object-side and sensor-side surfaces of the first to seventh lenses 101 to 107. The size of the effective aperture of the sensor-side fourteenth surface S14 of the seventh lens 107 may be more than two times and less than four times the size of the effective aperture of the third surface S3 of the second lens 102. Accordingly, the optical system 1000 can reduce chromatic aberration and improve vignetting characteristics.

The effective aperture of each of the first to seventh lenses 101 to 107 is defined as the average value of the effective apertures of the object-side surface and sensor-side surface of each lens. At this time, the average effective aperture of the second and third surfaces S2 and S3 of the second lens 102, that is, the effective aperture of the second lens 102, may be the smallest among the lenses. That is, explaining the size of the effective region through which effective light passes, the effective aperture of the third surface S3 of the second lens 102 may be smaller than the effective aperture H3 of the third lens 103. Additionally, the average effective aperture of the thirteenth and fourteenth surfaces S13 and S14 of the seventh lens 107, that is, the effective aperture of the seventh lens 107, may be the largest among the lenses. The effective aperture of the seventh lens 107 may be more than twice the effective aperture of the second lens 102, for example, more than 2 times and less than 4 times. The effective aperture of the object-side surface of the second lens 102 may be the effective aperture of the bonded second surface S2. The size of the effective aperture H1 of the first surface S1 of the first lens 101 may be larger than the size of the effective apertures of the second surface S2 and the third surface S3. At least one or both of the second surface S2 and the third surface S3 may be aspherical. The aspherical coefficients of the second and third surfaces S2 and S3 are provided as shown in FIG. 3, where L2 is the second lens 102 and S1/S2 represent the first/second surfaces of L2. S1 of L2 and S2 of L1 are bond surfaces and may have the same aspheric coefficient.

Among the first and second lenses 101 and 102, the absolute value of the focal length of the second lens 102 may be greater. The first and second lenses 101 and 102 may have different center thicknesses CT. In detail, among the first and second lenses 101 and 102, the center thickness of the first lens 101 may be greater than the center thickness of the second lens 102. Among the first and second lenses 101 and 102, the second lens 102 may have a higher refractive index than the first lens 101. The refractive index of the second lens 102 may be greater than 1.6, and the refractive index of the first lens 101 may be less than 1.6. The Abbe number of the second lens 102 may be smaller than that of the first lens 101, for example, may be 15 or more smaller than the Abbe number of the first lens 101. The aberration can be improved by using the difference in refractive index and Abbe number of the lenses of the first lens group G1.

Among the first and second lenses 101 and 102, the size of the effective aperture (CA) of the lens may be the smallest on the sensor-side surface of the second lens 102, and the size of the effective aperture (CA) of the object-side surface the first lens 101 may be the largest. In detail, the size of the effective aperture of the sensor-side fourth surface S4 of the second lens 102 may be the smallest among the first to third surfaces S1 to S3. In addition, the size of the effective aperture of the sensor-side fourth surface S4 of the second lens 102 may be the smallest of the object-side surfaces or the sensor-side surface of the first to seventh lenses 101 to 107. Accordingly, the optical system 1000 can control incident light to improve resolution and chromatic aberration control characteristics, and can improve vignetting characteristics of the optical system 1000.

At least one of the third to seventh lenses 103 to 107 may have a refractive index of more than 1.6. Among the third to seventh lenses 103 to 107, the third lens 103 may have the highest refractive index, which may be greater than 1.6, and the refractive index of the fourth, fifth, sixth, and seventh lenses 104, 105, 106 and 107 may have a refractive index less than 1.6. The number of lenses with a refractive index greater than 1.6 in the optical system 1000 may be 30% or less of the total number or 2 or less. At least one of the third to seventh lenses 103, 104, 105, 106, and 107 may have an Abbe number of 45 or more. Among the third to seventh lenses 103, 104, 105, 106, and 107, the fourth lens 104 may have the largest Abbe number, which may be 45 or more, and the third, fifth, sixth, and seventh lenses 103, 105, 106 and 107 may have the Abbe number of less than 45. In the optical system 1000, the number of lenses having an Abbe number greater than 40 may be less than 50% of the total number or less than 3 lenses. Among the first to seventh lenses 101 to 107, the number of lenses having at least one inflection point may be 40% or more, for example, in the range of 40% to 60%. Among the lens surfaces of the first to seventh lenses 101 to 107, the sum of surfaces having inflection points may be 40% or more, for example, in the range of 40% to 60%.

Referring to FIG. 2, in an embodiment of the invention, the fourteenth surface S14 of the seventh lens 107 may have at least one inflection point P1. A tangent line K1 passing through an arbitrary point of the fourteenth surface S14 of the seventh lens 107 and a normal line K2 perpendicular to the tangent line K1 may have an optical axis OA and a predetermined angle θ1. The angle θ1 can be expressed as a slope value at the tangent line K1, and can have a maximum of more than 5 degrees and less than 45 degrees. Here, the inflection point may mean a point on the lens surface where the slope of the normal line K2 and the optical axis OA is 0. The inflection point P1 on the fourteenth surface S14 may mean a point where the slope of an imaginary line extending in a direction perpendicular to the tangent K1 and the optical axis OA is 0, and may be defined as the first inflection point. The first inflection point P1 may be a point at which the sign of the slope value in the direction perpendicular to the optical axis OA and the optical axis OA changes from positive (+) to negative (−) or negative (−) to positive (+), and may mean a point at which the slope value is 0. For example, the fourteenth surface S14 may have a first inflection point P1 at a predetermined distance CP1 from the optical axis OA. The first inflection point P1 may be located in a range of 40% or more, for example, 40% to 60%, of the effective radius r7 of the fourteenth surface S14 based on the optical axis OA. The effective radius r7 is a straight distance from the optical axis OA to the end of the effective region of the fourteenth surface S14. Here, the position of the first inflection point P1 is a position set based on the direction perpendicular to the optical axis OA, and can be spaced apart by the straight distance CP1 from the optical axis OA to the first inflection point P1. The inflection point position of the thirteenth surface S13 may be located closer to the optical axis OA or closer to the end of the effective region than the first inflection point.

It is preferable that the position of the first inflection point P1 disposed on the seventh lens 107 satisfies the above-mentioned range in consideration of the optical characteristics of the optical system 1000. In detail, the position of the first inflection point P1 preferably satisfies the above-mentioned range for controlling optical characteristics, for example, distortion characteristics, of the periphery portion of the FOV. Additionally, the optical system 1000 can implement good optical performance in the center and periphery portions of the FOV and have improved aberration characteristics.

Referring to FIG. 2, the position of the first inflection point P1 is the maximum Sag value (Sag_L7S2_max) of the fourteenth surface S14, d7_CT is the center thickness or optical axis thickness of the seventh lens 107, and L7_ET is the edge thickness of the seventh lens 107. d6_CT is the center thickness or optical axis thickness of the sixth lens 106, and L6_ET is the edge thickness of the sixth lens 106. The edge thickness L7_ET of the seventh lens 107 is the distance in the optical axis direction from the end of the effective region of the thirteenth surface S13 to the effective region of the fourteenth surface 514. A second thickness L7S2_PT2 of a second region that protrudes toward the sensor side beyond the straight line perpendicular to the optical axis OA of the fourteenth surface S14 on the first inflection point P1 may be smaller than the first thickness L7S1_PT1 of a first region that protrudes the sensor side beyond the straight line perpendicular to the optical axis OA on the thirteenth surface S13. The first thickness L7S1_PT1 may be 3 times or more, for example, 3 to 10 times or 5 to 10 times the second thickness L7S2_PT2.

d67_CT is an optical axis distance (i.e., center interval) from the center of the sixth lens 106 to the center of the seventh lens 107. That is, the optical axis distance d67_CT from the center of the sixth lens 106 to the center of the seventh lens 107 is the distance from the center of the twelfth surface S12 to the center of the thirteenth surface S13.

d67_ET is a distance (i.e., edge interval) in the optical axis direction from the edge of the sixth lens 106 to the edge of the seventh lens 107. That is, the distance d67_ET in the optical axis direction from the edge of the sixth lens 106 to the edge of the seventh lens 107 is a distance in the optical axis direction between a straight line extending in the circumferential direction from the end of the effective region of the twelfth surface S12 and the ends of the effective region of the thirteenth surface S13. Back focal length (BFL) is the optical axis distance from the image sensor 300 to the last lens. In this way, the center thickness, edge thickness, and center distance and edge distance between two adjacent lenses of the first to seventh lenses 101 to 107 may be set.

As shown in FIG. 7(A)(B), it is a graph showing the height in the optical axis direction from the optical axis OA to the end of the effective region for the object-side surface (L7S1) and the sensor-side surface (L7S2) of the seventh lens 107. L7S1 is the thirteenth surface S13, L7S2 is the fourteenth surface S14, and it can be seen that the distance in the optical axis direction of L7S1 gradually increases from the center (0) to the end of the effective region. It can be seen that L7S2 increases the distance in the optical axis direction from the center (0) to the end of the effective region to the position of the first inflection point, that is, 2.2 mm±0.1 mm, and then decreases again.

As shown in FIGS. 4 and 1, a distance between adjacent lenses may be provided, for example, in a region spaced at a predetermined distance (e.g., 0.1 mm) along the first direction Y with respect to the optical axis OA, and may be represented as a first distance d12 between the first and second lenses 101 and 102, a second distance d23 between the second and third lenses 102 and 103, a third distance d34 between the third and fourth lenses 103 and 104, a fourth distance d45 between the fourth and fifth lenses 104 and 105, a fifth distance d56 between the fifth and sixth lenses 105 and 106, and a sixth distance d67 between the sixth and seventh lenses 106 and 107. The first direction Y may include a circumferential direction centered on the optical axis OA or two directions orthogonal to each other, and the distance between two adjacent lenses at the end in the first direction Y may be based on the end of the effective region of the lens having a smaller effective radius, and the end of the effective radius may include an error of the end ±0.2 mm.

The first distance d12 may be a distance in the optical axis direction Z between the first lens 101 and the second lens 102 along the first direction Y. When the optical axis OA is a starting point and an end point of an effective region of the third surface S3 of the second lens 102 is the endpoint, the first distance d12 may be constant without a change from the optical axis OA to the first direction Y. The first distance d12 may be absent due to the bonded second surface S2. Accordingly, the optical system 1000 can effectively control incident light. In detail, since the first lens 101 and the second lens 102 are provided as cemented lens, light incident through the first and second lenses 101 and 102 can maintain good optical performance.

The second distance d23 may be a distance in the optical axis direction Z between the second lens 102 and the third lens 103. The second distance d23 may become smaller as it goes from the optical axis OA toward the end point in the first direction Y. The second distance d23 may be maximum at the optical axis OA or the starting point and minimum at the end point. The maximum value of the second distance d23 may be 1.5 times or more than the minimum value. In detail, the maximum value of the second distance d23 may satisfy 1.5 to 2.5 times the minimum value. Accordingly, the optical system 1000 may have improved optical characteristics. In detail, as the second lens 102 and the third lens 103 are spaced apart by the second distance d23 set according to their positions, the aberration characteristics of the optical system 1000 can be improved. The second distance d23 may be the distance between the first and second lens groups G1 and G2.

The third distance d34 may be a distance in the optical axis direction Z between the third lens 103 and the fourth lens 104. When the third distance d34 takes the optical axis OA as the starting point and the end point of the effective region of the sixth surface S6 of the third lens 103 as the end point in the first direction Y, the third distance d34 may gradually increase from the optical axis OA toward the end point of the first direction Y, and may become smaller again around the end point. That is, the third distance may have a minimum value at the optical axis OA and a maximum value around the end point. The maximum value may be 2.5 times or more, for example, 2.5 to 4 times the minimum value. The maximum value of the third distance d34 may be greater than the maximum value of the second distance d23, for example, in the range of 1.1 to 2.5 times, and the minimum value of the third distance d34 may be greater than the minimum value of the second distance d23. Accordingly, the optical system 1000 may have improved optical characteristics. In detail, as the third lens 103 and the fourth lens 104 are separated by the third distance d34 set according to position, the optical system 1000 may have improved chromatic aberration characteristics. Additionally, the optical system 1000 can control vignetting characteristics.

The fourth distance d45 may be a distance in the optical axis direction Z between the fourth lens 104 and the fifth lens 105. When the fourth distance d45 is set as the starting point of the optical axis OA and the end point of the effective region of the eighth surface S8 of the fourth lens 104, the fourth distance d45 may be increased in the first direction Y from the start point to the end point. The minimum value of the fourth distance d45 may be located at the optical axis OA or the starting point, and the maximum value may be located at the end point or around the end point. Here, the fourth distance d45 may be smaller than the distance from the optical axis OA than the distance from the end point. Accordingly, the optical system 1000 may have improved optical characteristics. As the fourth lens 104 and the fifth lens 105 are spaced apart by the fourth distance d45 set according to the position, the optical system 1000 provides good optical performance in the center and periphery portions of the FOV, and may adjust improved chromatic aberration and distortion aberration.

The fifth distance d56 may be a distance in the optical axis direction Z between the fifth lens 105 and the sixth lens 106. When the optical axis OA is set as a starting point and an end of the effective region of the tenth surface S10 of the fifth lens 105 is set as an end point, the fifth distance d56 may change from the optical axis OA toward a vertical first direction Y. The maximum value of the fifth distance d56 may be located in a range of 95% or more, for example, 95% to 100% of the distance from the optical axis OA to the end point. The minimum value of the fifth distance d56 is located at the optical axis, and the maximum value may be at least twice the minimum value, for example, in the range of 2 to 5 times. The minimum value of the fifth distance d56 is greater than the maximum value of the third distance d34, and the maximum value of the fifth distance d56 may be in the range between the maximum and minimum values of the second distance d23. Accordingly, the optical system 1000 may have improved optical characteristics in the center and periphery portions of the FOV. In addition, the optical system 1000 may have improved aberration control characteristics as the fifth lens 105 and the sixth lens 106 are spaced apart by the fifth distance d56 set according to the position, and the sixth lens 106 may have improved aberration control characteristics. The size of the effective aperture of the lens 106 can be appropriately controlled.

The sixth lens 106 and the seventh lens 107 may be spaced apart in the optical axis direction Z by a sixth distance d67. When the optical axis OA is set as a starting point and an end of the effective region of the twelfth surface S12 of the sixth lens 106 is set as an end point, the sixth distance d67 may change from the optical axis OA toward a vertical first direction Y. The maximum value of the sixth distance d67 is located at the optical axis OA, and the minimum value may be located at least 68% of the distance from the optical axis OA to the end point, for example, in the range of 68% to 95%. The sixth distance d67 gradually increases from the position of the minimum value toward the optical axis OA, and may gradually increase from the position of the minimum value toward the end point. The maximum value of the sixth distance d67 may be 3 times or more, for example, 3 to 6 times the minimum value. The maximum value of the sixth distance d67 may be 1 time or more, for example, 1 to 2 times the maximum value of the second distance d23, and the minimum value the sixth distance d67 may be smaller than the minimum value of the second distance d23. Accordingly, the optical system 1000 may have improved optical characteristics in the center and periphery portions of the FOV. In addition, the optical system 1000 may improve the distortion and aberration characteristics of the periphery portion of the FOV as the sixth lens 106 and the seventh lens 107 are spaced apart by the sixth distance d67 set according to the position.

Among the lenses 101-107, the maximum center thickness may be 3.5 times or more, for example, 3.5 to 5 times the minimum center thickness. The sixth lens 106 having the maximum center thickness may be 3.5 times or more, for example, 3.5 to 5 times the thickness of the second or third lenses 102 and 103 having the minimum center thickness. Among the plurality of lenses 100, the number of lenses with a center thickness of less than 0.5 mm may be greater than the number of lenses with a center thickness of 0.5 mm or more. Among the plurality of lenses 100, the number of lenses smaller than 0.5 mm may exceed 50% of the total number of lenses. Accordingly, the optical system 1000 can be provided in a structure with a slim thickness.

Among the plurality of lens surfaces, the number of surfaces with an effective radius of less than 2 mm may be less than the number of surfaces with an effective radius of 2 mm or more, for example, may be less than 50% of the total lens surface. When the curvature radius is described as an absolute value, the curvature radius of the second surface S2, which is the bonded surface, among the plurality of lenses 100 may be the largest among the lens surfaces, and may be 50 times or more, for example, 50 to 100 times the curvature radius of the first surface S1 of the first lens 101 or the thirteenth surface S13. When the focal length is described as an absolute value, the focal length of the third lens 103 among the plurality of lenses 100 may be the largest among the lenses, and may be more than 5 times the focal length of the seventh lens 107, for example, in a range of 5 to 10 times.

Table 1 is an example of lens data of the optical system of FIG. 1.

TABLE 1

| | | | Thickness | | | |
|---|---|---|---|---|---|---|
| | | Curvature | (mm)/ | Re- | | Effective |
| | | radius | Distance | fractive | Abbe | aperture |
| Lens | Surface | (mm) | (mm) | index | number | (mm) |
| Lens 1 | S1 | 2.687 | 0.942 | 1.549 | 43.313 | 3.576 |
| | S2 | | | | | |
| Lens 2 | S3 | 179.074 | 0.252 | 1.659 | 19.275 | 3.286 |
| | (Stop) | | | | | |
| | S4 | 8.862 | 0.745 | | | 2.932 |
| Lens 3 | S5 | −4.665 | 0.254 | 1.690 | 17.000 | 3.101 |
| | S6 | −6.640 | 0.044 | | | 3.386 |
| Lens 4 | S7 | 29.293 | 0.803 | 1.545 | 47.919 | 3.547 |
| | S8 | −19.235 | 0.536 | | | 4.099 |
| Lens 5 | S9 | 39.660 | 0.465 | 1.583 | 31.931 | 4.673 |
| | S10 | 6.528 | 0.208 | | | 5.233 |
| Lens 6 | S11 | 4.436 | 1.107 | 1.556 | 42.392 | 5.719 |
| | S12 | −4.163 | 0.888 | | | 6.697 |
| Lens 7 | S13 | −2.908 | 0.485 | 1.555 | 39.419 | 7.338 |
| | S14 | 5.821 | 0.305 | | | 8.822 |
| Filter | | Infinity | 0.230 | | | 9.866 |
| | | Infinity | 0.480 | | | 10.022 |
| Image | | Infinity | 0.027 | | | 10.592 |
| sensor | | | | | | |

Table 1 shows the curvature radius, the thickness of the lens, the distance between the lenses on the optical axis OA of the first to seventh lenses 101-107 of FIG. 1, the refractive index at d-line, Abbe Number, and effective aperture (CA: Clear aperture). As shown in FIG. 3, a lens surface of at least one of the plurality of lenses 100 in the first embodiment may include an aspheric surface with a 30th order aspherical coefficient. For example, the first to seventh lenses 101 to 107 may include a lens surface having a 30th order aspheric coefficient. As described above, an aspheric surface with a 30th order aspherical coefficient (a value other than “0”) can particularly significantly change the aspheric shape of the periphery portion, so the optical performance of the periphery portion of the FOV can be well corrected.

FIG. 5 is a graph showing the diffraction MTF characteristics of the optical system 1000 according to the first embodiment, and FIG. 6 is a graph showing the aberration characteristics. In the aberration graph in FIG. 6, longitudinal spherical aberration, astigmatic field curves, and distortion aberration are measured from left to right. In FIG. 6, the X-axis may represent a focal length (mm) and distortion (%), and the Y-axis may mean the height of an image. In addition, the graph for spherical aberration is a graph for light in a wavelength band of about 470 nm, about 510 nm, about 555 nm, about 610 nm, and about 650 nm, and the graph for astigmatism and distortion aberration is a graph for light in the about 555 nm wavelength band.

In the aberration diagram of FIG. 6, it may be interpreted that the closer each curve is to the Y-axis, the better the aberration correction function. Referring to FIG. 6, it may be seen that the measured values of the optical system 1000 according to the embodiment are adjacent to the Y-axis. That is, the optical system 1000 according to the embodiment may have improved resolution and good optical performance not only in the center portion of FOV but also in the periphery portion.

The second embodiment will be described with reference to FIGS. 8 to 14.

Referring to FIGS. 8 and 9, the optical system 1000 according to the second embodiment of the invention may be composed of a plurality of lenses 100A, that is, the first to seventh lenses 111 to 117. The first and second lenses 111 and 112 may be the first lens group G1 or the sensor-side lens group, and the third to seventh lenses 113-117 may be the second lens group G2 or the object-side lens group.

The first lens 111 is the lens closest to the object in the first lens group G1. The first lens 111 may have positive (+) refractive power on the optical axis OA. The first lens 111 may include plastic or glass. Preferably, the first lens 111 may be made of plastic. The first lens 111 may have a meniscus shape that is convex toward the object. To explain further, the first surface S1 may have a convex shape on the optical axis OA, and the second surface S2 may have a concave shape on the optical axis OA. Differently, among the first and second surfaces S1 and S2, the second surface S2 may have a convex shape on the optical axis OA. That is, the first lens 111 may have a shape in which both sides are convex on the optical axis OA. At least one or both of the first surface S1 and the second surface S2 may be aspherical. The aspheric coefficients of the first and second surfaces S1 and S2 are provided as shown in FIG. 10, where L1 is the first lens 111 and S1/S2 represent the first/second surfaces of L1.

The second lens 112 may be disposed between the first lens 111 and the third lens 113. The second lens 112 may have negative refractive power on the optical axis OA. The second lens 112 may include plastic or glass. For example, the second lens 112 may be made of plastic. The second surface S2 of the second lens 112 may have a convex shape on the optical axis OA, and the third surface S3 may have a concave shape on the optical axis. Here, the first lens 111 and the second lens 112 may be a cemented lens. The sensor-side surface of the first lens 111 and the object-side surface of the second lens 112 are bonded to each other and may be the second surface S2. The second surface S2 is a sensor-side surface of the first lens 111, and may have a concave shape on the optical axis OA with respect to the first lens 111, and may have a convex shape with respect to the second lens 112. Differently, among the second and third surfaces S2 and S3, the second surface S2 may have a concave shape on the optical axis OA. The third surface S3 may have a convex shape on the optical axis OA.

The effective aperture of the sensor-side surface of the first lens 111 and the object-side surface of the second lens 112 may be the effective aperture of the bonded second surface S2. The size of the effective aperture H1 of the first surface S1 of the first lens 111 may be larger than the size of the effective aperture of the second surface S2 and the third surface S3. At least one or both of the second surface S2 and the third surface S3 may be aspherical. The aspherical coefficients of the second and third surfaces S2 and S3 are provided as shown in FIG. 10, where L2 is the second lens 112 and S1/S2 represent the first/second surfaces of L2. S1 of L2 and S2 of L1 are bond surfaces and may have the same aspheric coefficient.

The absolute value of the focal length of the first and second lenses 111 and 112, the focal length of the second lens 112 may be greater than that of the first lens 111. The first and second lenses 111 and 112 may have different center thicknesses CT. In detail, among the first and second lenses 111 and 112, the center thickness of the first lens 111 may be greater than the center thickness of the second lens 112. Among the first and second lenses 111 and 112, the second lens 112 may have a higher refractive index than that of the first lens 111. The refractive index of the second lens 112 may be greater than 1.6, and the refractive index of the first lens 111 may be less than 1.6. The Abbe number of the second lens 112 may be smaller than that of the first lens 111, for example, may be 15 or more smaller than the Abbe number of the first lens 111. The aberration can be improved by using the difference in refractive index and Abbe number of the lenses of the first lens group G1.

The effective aperture (CA) of the lens surfaces of the first and second lenses 111 and 112, may be the smallest on the sensor-side surface of the second lens 112, and the effective aperture (CA) of the first lens 111 may be the smallest and the object-side surface of the first lens 111 may be the largest. In detail, the effective aperture of the sensor-side third surface S3 of the second lens 112 may be the smallest among the first to third surfaces S1, S2, and S3. In addition, the size of the effective aperture of the sensor-side third surface S3 of the second lens 112 may be the smallest of the object-side surfaces and the sensor-side surfaces of the first to seventh lenses 111 to 117. Accordingly, the optical system 1000 can control incident light to improve resolution and chromatic aberration control characteristics, and can improve vignetting characteristics of the optical system 1000.

The third lens 113 is the lens closest to the object within the second lens group G2. The third lens 113 may have positive (+) or negative (−) refractive power on the optical axis OA. The third lens 113 may have negative (−) refractive power. The third lens 113 may include plastic or glass. For example, the third lens 113 may be made of plastic. The third lens 113 may have a meniscus shape that is convex from the optical axis OA toward the sensor. To explain further, the fifth surface S5 may have a concave shape on the optical axis OA, and the sixth surface S6 may have a convex shape on the optical axis OA. Alternatively, the third lens 113 may have a shape that is concave on both sides or convex on both sides at the optical axis OA. The object-side surface or sensor-side surface of the third lens 113 may be provided without an inflection point. At least one or both of the fifth surface S5 and the sixth surface S6 may be aspherical. The aspherical coefficients of the fifth and sixth surfaces S5 and S6 are provided as shown in FIG. 10, where L3 is the third lens 113, and S1/S2 represent the first/second or fifth/sixth surfaces of L3.

The fourth lens 114 may have positive (+) or negative (−) refractive power on the optical axis OA. The fourth lens 114 may have positive refractive power. The fourth lens 114 may include plastic or glass. For example, the fourth lens 114 may be made of plastic. The fourth lens 114 may have a shape in which both sides are convex on the optical axis OA. To explain further, the seventh surface S7 may have a convex shape on the optical axis OA, and the eighth surface S8 may have a convex shape on the optical axis OA. Alternatively, the fourth lens 114 may have a meniscus shape convex toward the object side or a meniscus shape convex toward the sensor side. Alternatively, the fourth lens 114 may have a concave shape on both sides of the optical axis OA. The object-side surface or sensor-side surface of the fourth lens 114 may be provided without an inflection point. At least one of the seventh surface S7 and the eighth surface S8 may be an aspherical surface. For example, both the seventh surface S7 and the eighth surface S8 may be aspherical. The aspherical coefficients of the seventh and eighth surfaces S7 and S8 are provided as shown in FIG. 10, where L4 is the fourth lens 114, and S1/S2 represent the first/second surfaces or seventh/eighth surfaces of L4.

The fifth lens 115 may have positive (+) or negative (−) refractive power on the optical axis OA. The fifth lens 115 may have negative (−) refractive power. The fifth lens 115 may include plastic or glass. For example, the fifth lens 115 may be made of plastic. The fifth lens 115 may have a meniscus shape that is convex toward the object. Preferably, the ninth surface S9 may have a convex shape from the optical axis OA toward the object, and the tenth surface S10 may have a concave shape from the optical axis OA. Alternatively, the fifth lens 115 may have a meniscus shape that is convex toward the sensor. To explain further, the ninth surface S9 may have a concave shape on the optical axis OA, and the tenth surface S10 may have a convex shape on the optical axis OA. Alternatively, the fifth lens 115 may have a concave or convex shape on both sides of the optical axis OA. At least one of the ninth surface S9 and the tenth surface S10 may have an inflection point. For example, both the ninth surface S9 and the tenth surface S10 may have inflection points. As another example, both the ninth surface S9 and the tenth surface S10 may be provided without inflection points. At least one of the ninth surface S9 and the tenth surface S10 may be an aspherical surface. For example, both the ninth surface S9 and the tenth surface S10 may be aspherical. The aspherical coefficients of the ninth and tenth surfaces S9 and S10 are provided as shown in FIG. 10, where L5 is the fifth lens 115, and S1/S2 represent the first/second surfaces or ninth/tenth surfaces of L5.

The sixth lens 116 may have positive (+) refractive power on the optical axis OA. The sixth lens 116 may include plastic or glass. For example, the sixth lens 116 may be made of plastic. The sixth lens 116 may have a shape in which both sides are convex on the optical axis OA. The eleventh surface S11 of the sixth lens 116 may have a convex shape on the optical axis OA, and the twelfth surface S12 may have a convex shape on the optical axis OA. At least one of the eleventh surface S11 and the twelfth surface S12 may have an inflection point. The eleventh surface S11 may have an inflection point formed at a predetermined position, and the twelfth surface S12 may have an inflection point or be provided without an inflection point. For example, the inflection point of the eleventh surface S11 may be located at a position greater than 50% of the distance (i.e., effective radius) from the optical axis OA to the end of the effective region, for example, in the range of 50% to 80%. In FIG. 2, the effective radius r6 of the twelfth surface S12 may be smaller than the effective radius r7 of the fourteenth surface 14, for example, 85% or less of the effective radius r7. At least one of the eleventh surface S11 and the twelfth surface S12 may be an aspherical surface. For example, both the eleventh surface S11 and the twelfth surface S12 may be aspherical. The aspherical coefficients of the eleventh and twelfth surfaces S11 and S12 are provided as shown in FIG. 10, L6 is the sixth lens 116, and S1/S2 are the first/second surfaces or eleventh/twelfth surfaces of L6.

The seventh lens 117 may have negative (−) refractive power on the optical axis OA. The seventh lens 117 may include plastic or glass. For example, the seventh lens 117 may be made of plastic. The seventh lens 117 may have a concave shape on both sides of the optical axis OA. The thirteenth surface S13 of the seventh lens 117 may have a concave shape on the optical axis OA, and the fourteenth surface S14 may have a concave shape on the optical axis OA. At least one of the thirteenth surface S13 and the fourteenth surface S14 may have an inflection point. For example, both the thirteenth surface S13 and the fourteenth surface S14 may have inflection points. The inflection point of the fourteenth surface S14 may be located at a position greater than 40% of the distance r7 from the optical axis OA to the end of the effective region, for example, in the range of 40% to 60%. The inflection point of the thirteenth surface S13 may be located at a position greater than 75% of the distance from the optical axis OA to the end of the effective region, for example, in the range of 75% to 95%. At least one of the thirteenth surface S13 and the fourteenth surface S14 may be an aspherical surface. For example, both the thirteenth surface S13 and the fourteenth surface S14 may be aspherical. The aspheric coefficients of the thirteenth and fourteenth surfaces S13 and S14 are provided as shown in FIG. 10, where L7 is the seventh lens 117, and S1/S2 represent the first/second surfaces or thirteenth/fourteenth surfaces of L7.

Among the third to seventh lenses 113 to 117, at least one of the object-side and sensor-side surfaces of the second lens 112 may have the smallest effective aperture (CA) of the lens surface, and at least one of the object-side and sensor-side surfaces of the seventh lens 117 may be the largest. In detail, the size of the effective aperture of the object-side third surface S3 of the second lens 112 may be the smallest among the object-side surface and sensor-side surfaces of the third to seventh lenses 113 to 117. The size of the effective aperture of the sensor-side fourteenth surface S14 of the seventh lens 117 may be the largest among the object-side and sensor-side surfaces of the first to seventh lenses 111 to 117. The size of the effective aperture of the sensor-side fourteenth surface S14 of the seventh lens 117 may be more than two times and less than four times the size of the effective aperture of the third surface S3 of the second lens 112. Accordingly, the optical system 1000 can reduce chromatic aberration and improve vignetting characteristics.

The effective aperture of each of the first to seventh lenses 111 to 117 is defined as the average value of the effective aperture of the object-side surface and sensor-side surface of each lens. At this time, the average effective aperture of the second and third surfaces S2 and S3 of the second lens 112, that is, the effective aperture of the second lens 112, may be the smallest among the lenses. That is, explaining the size of the effective region through which effective light passes, the effective aperture of the third surface S3 of the second lens 112 may be smaller than the effective aperture H3 of the third lens 113. In addition, the average effective aperture of the thirteenth and fourteenth surfaces S13 and S14 of the seventh lens 117, that is, the effective aperture of the seventh lens 117, may be the largest among the lenses. The effective aperture of the seventh lens 117 may be more than twice the effective aperture of the second lens 112, for example, more than 2 times and less than 4 times.

At least one of the plurality of lenses 100A may have a refractive index greater than 1.6. Among the plurality of lenses 100A, the third lens 113 may have the highest refractive index, the refractive index of the second and third lenses 112 and 113 may be greater than 1.6, and the first, fourth, fifth, sixth, and seventh lenses 111, 114, 115, 116, and 117 may have a higher refractive index less than 1.6. The number of lenses with a refractive index greater than 1.6 in the optical system 1000 may be 30% or less of the total number or two or less. At least one of the plurality of lenses 100A may have an Abbe number of 45 or more. Among the plurality of lenses 100A, the sixth lens 116 may have the largest Abbe number, which may be 45 or more, and the Abbe number of the first to fifth lenses 111-115 may be less than 45. In the optical system 1000, the number of lenses having an Abbe number greater than 40 may be less than 50% of the total number or three lenses or less. Among the first to seventh lenses 111 to 117, the number of lenses having at least one inflection point may be 40% or more, for example, in the range of 40% to 60%. Among the lens surfaces of the first to seventh lenses 111 to 117, the sum of surfaces having inflection points may be 40% or more, for example, in the range of 35% to 55%.

Referring to FIG. 9, in an embodiment of the invention, the fourteenth surface S14 of the seventh lens 117 may have at least one inflection point P1. A tangent line K1 passing through an arbitrary point of the fourteenth surface S14 of the seventh lens 117 and a normal line K2 perpendicular to the tangent line K1 may have an optical axis OA and a predetermined angle θ1. The angle θ1 can be expressed as a slope value at the tangent line K1, and can have a maximum of more than 5 degrees and less than 45 degrees. Here, the inflection point may mean a point on the lens surface where the slope of the normal line K2 and the optical axis OA is 0. The inflection point P1 on the fourteenth surface S14 may mean a point where the slope of an imaginary line extending in a direction perpendicular to the tangent K1 and the optical axis OA is 0, and may be defined as the first inflection point. The first inflection point P1 may be a point at which the sign of the slope value in the direction perpendicular to the optical axis OA and the optical axis OA changes from positive (+) to negative (−) or negative (−) to positive (+), and may mean a point at which the slope value is 0. For example, the fourteenth surface S14 may have a first inflection point P1 at a predetermined distance CP1 from the optical axis OA. The first inflection point P1 may be located in a range of 30% or more, for example, 30% to 50%, of the effective radius r7 of the fourteenth surface S14 based on the optical axis OA. The effective radius r7 is a straight distance from the optical axis OA to the end of the effective region of the fourteenth surface S14. Here, the position of the first inflection point P1 is a position set based on the direction perpendicular to the optical axis OA, and can be spaced by the straight distance CP1 from the optical axis OA to the first inflection point P1. The inflection point position of the thirteenth surface S13 may be located closer to the optical axis OA or closer to the end of the effective region than the first inflection point. It is preferable that the position of the first inflection point P1 disposed on the seventh lens 117 satisfies the above-described range in consideration of the optical characteristics of the optical system 1000. In detail, the position of the first inflection point P1 preferably satisfies the above-mentioned range for controlling optical characteristics, for example, distortion characteristics, of the periphery portion of the FOV. Additionally, the optical system 1000 can implement good optical performance in the center and periphery portions of the FOV and have improved aberration characteristics.

Referring to FIG. 2, the position of the first inflection point P1 is the maximum Sag value (Sag_L7S2_max) of the fourteenth surface 514, d7_CT is the center thickness or optical axis thickness of the seventh lens 117, and L7_ET is the edge thickness of the seventh lens 117. d6_CT is the center thickness or optical axis thickness of the sixth lens 116, and L6_ET is the edge thickness of the sixth lens 117. The edge thickness L7_ET of the seventh lens 117 is the distance in the optical axis direction from the end of the effective region of the thirteenth surface S13 to the effective region of the fourteenth surface 514. The second thickness L7S2_PT2 of the second region protruding toward the sensor beyond the straight line perpendicular to the optical axis OA of the fourteenth surface S14 on the first inflection point P1 may be smaller than the first thickness L7S1_PT1 of the first region that protrudes toward the sensor than the straight line perpendicular to the optical axis OA on the thirteenth surface 513. The first thickness L7S1_PT1 may be 3 times or more, for example, 3 to 10 times, or 3 to 7 times the second thickness L7S2_PT2.

d67_CT is the optical axis distance (i.e., center interval) from the center of the sixth lens 116 to the center of the seventh lens 117. That is, the optical axis distance d67_CT from the center of the sixth lens 116 to the center of the seventh lens 117 is the distance from the center of the twelfth surface S12 to the center of the thirteenth surface S13. d67_ET is the distance (i.e., edge interval) in the optical axis direction from the edge of the sixth lens 116 to the edge of the seventh lens 117. That is, the distance d67_ET in the optical axis direction from the edge of the sixth lens 116 to the edge of the seventh lens 117 is a distance in the optical axis direction between a straight line extending in the circumferential direction from the end of the effective region of the twelfth surface S12 and the ends of the effective region of the thirteenth surface S13.

As shown in FIG. 14(A)(B), it is a graph showing the height in the optical axis direction from the optical axis OA to the end of the effective region for the object-side surface (L7S1) and the sensor-side surface (L7S2) of the seventh lens 117. L7S1 is the thirteenth surface 513, L7S2 is the fourteenth surface S14, and it can be seen that the distance in the optical axis direction of L7S1 gradually increases from the center (0) to the end of the effective region. It can be seen that L7S2 increases the distance in the optical axis direction from the center (0) to the end of the effective region to the position of the first inflection point, that is, 2 mm±0.1 mm, and then decreases again.

As shown in FIGS. 11 and 8, a distance between adjacent lenses may be provided, for example, in a region spaced at a predetermined distance (e.g., 0.1 mm) along the first direction Y with respect to the optical axis OA, and may be represented as a first distance d12 between the first and second lenses 111 and 112, a second distance d23 between the second and third lenses 112 and 113, a third distance d34 between the third and fourth lenses 113 and 114, a fourth distance d45 between the fourth and fifth lenses 114 and 115, a fifth distance d56 between the fifth and sixth lenses 115 and 116, and a sixth distance d67 between the sixth and seventh lenses 116 and 117. The first direction Y may include a circumferential direction centered on the optical axis OA or two directions orthogonal to each other, and the distance between two adjacent lenses at the end in the first direction Y may be based on the end of the effective region of the lens having a smaller effective radius, and the end of the effective radius may include an error of the end ±0.2 mm.

The first distance d12 may be the distance in the optical axis direction Z between the first lens 111 and the second lens 112 along the first direction Y. When the optical axis OA is a starting point and an end point of an effective region of the third surface S3 of the second lens 112 is the endpoint, the first distance d12 may be constant without a change from the optical axis OA to the first direction Y. The first distance d12 may be absent due to the bonded second surface S2. Accordingly, the optical system 1000 can effectively control incident light. In detail, since the first lens 111 and the second lens 112 are provided as cemented lens, light incident through the first and second lenses 111 and 112 can maintain good optical performance.

The second distance d23 may be the distance in the optical axis direction Z between the second lens 112 and the third lens 113. The second distance d23 may become smaller as it goes from the optical axis OA toward the end point in the first direction Y. The second distance d23 may be maximum at the optical axis OA or the starting point and minimum at the end point. The maximum value of the second distance d23 may be 1.5 times or more than the minimum value. In detail, the maximum value of the second distance d23 may satisfy 1.5 to 2.5 times the minimum value. Accordingly, the optical system 1000 may have improved optical characteristics. In detail, as the second lens 112 and the third lens 113 are spaced apart by the second distance d23 set according to their positions, the aberration characteristics of the optical system 1000 can be improved. The second distance d23 may be the distance between the first and second lens groups G1 and G2.

The third distance d34 may be a distance in the optical axis direction Z between the third lens 113 and the fourth lens 114. The third distance d34 is set as the starting point of the optical axis OA and the end point of the effective region of the sixth surface S6 of the third lens 113 as the end point of the first direction Y. The distance d34 may gradually increase from the optical axis OA toward the end point of the first direction Y, and may become smaller again around the end point. That is, the third distance may have a minimum value at the optical axis OA and a maximum value around the end point. The maximum value may be 2.5 times or more, for example, 2.5 to 4 times the minimum value. The maximum value of the third distance d34 may be greater than the maximum value of the second distance d23, for example, in the range of 1.1 to 2.5 times, and the minimum value of the third distance d34 may be smaller than the minimum value of the second distance d23. Accordingly, the optical system 1000 may have improved optical characteristics. In detail, as the third lens 113 and the fourth lens 114 are separated by a third distance d34 set according to their positions, the optical system 1000 may have improved chromatic aberration characteristics. Additionally, the optical system 1000 can control vignetting characteristics.

The fourth distance d45 may be the distance in the optical axis direction Z between the fourth lens 114 and the fifth lens 115. When the fourth distance d45 is set as the starting point of the optical axis OA and the end point of the effective region of the eighth surface S8 of the fourth lens 114, the fourth distance d45 may be increased in the first direction Y from the start point to the end point. The minimum value of the fourth distance d45 may be located at the optical axis OA or the starting point, and the maximum value may be located at the end point or around the end point. Here, the fourth distance d45 may be smaller than the distance from the optical axis OA than the distance from the end point. Accordingly, the optical system 1000 may have improved optical characteristics. As the fourth lens 114 and the fifth lens 115 are spaced apart by a fourth distance d45 set according to the position, the optical system 1000 provides good optical performance in the center and periphery portions of the FOV, and may control improved chromatic aberration and distortion aberration.

The fifth distance d56 may be the distance in the optical axis direction Z between the fifth lens 115 and the sixth lens 116. When the optical axis OA is set as a starting point and an end of the effective region of the tenth surface S10 of the fifth lens 115 is set as an end point, the fifth distance d56 may change from the optical axis OA toward a vertical first direction Y. The maximum value of the fifth distance d56 may be located in a range of 95% or more, for example, 95% to 100% of the distance from the optical axis OA to the end point. The minimum value of the fifth distance d56 is located at the optical axis, and the maximum value may be at least twice the minimum value, for example, in the range of 2 to 5 times. The minimum value of the fifth distance d56 is smaller than the maximum value of the third distance d34, and the maximum value of the fifth distance d56 may be in the range between the maximum and minimum values of the second distance d23. Accordingly, the optical system 1000 may have improved optical characteristics in the center and periphery portions of the FOV. In addition, the optical system 1000 may have improved aberration control characteristics as the fifth lens 115 and the sixth lens 116 are separated by the fifth distance d56 set according to the position, and the sixth lens 116 may have improved aberration control characteristics. The size of the effective aperture of the lens 116 can be appropriately controlled.

The sixth lens 116 and the seventh lens 117 may be spaced apart in the optical axis direction Z by a sixth distance d67. When the optical axis OA is set as a starting point and an end of the effective region of the twelfth surface S12 of the sixth lens 116 is set as an end point, the sixth distance d67 may change from the optical axis OA toward a vertical first direction Y. The maximum value of the sixth distance d67 is located at the optical axis OA, and the minimum value may be located at least 68% of the distance from the optical axis OA to the end point, for example, in the range of 68% to 95%. The sixth distance d67 gradually increases from the position of the minimum value toward the optical axis OA, and may gradually increase from the position of the minimum value toward the end point. The maximum value of the sixth distance d67 may be 3 times or more, for example, 3 to 6 times the minimum value. The maximum value of the sixth distance d67 may be 1 time or more, for example, 1 to 2 times the maximum value of the second distance d23, and the minimum value of the sixth distance d67 may be smaller than the minimum value of the second distance d23. Accordingly, the optical system 1000 may have improved optical characteristics in the center and periphery portions of the FOV. In addition, the optical system 1000 may improve the distortion and aberration characteristics of the periphery portion of the FOV as the sixth lens 116 and the seventh lens 117 are spaced apart by the sixth distance d67 set according to the position.

Among the lenses 111-117, the maximum center thickness may be 3.5 times or more, for example, 5 to 10 times the minimum center thickness. The sixth lens 116 having the maximum center thickness may be 5 times or more, for example, 5 to 10 times the range of the second, third or seventh lenses 112, 113, or 117 having the minimum center thickness. Among the plurality of lenses 100A, the number of lenses with a center thickness of less than 0.5 mm may be greater than the number of lenses with a center thickness of 0.5 mm or more. Among the plurality of lenses 100A, the number of lenses smaller than 0.5 mm may exceed 50% of the total number of lenses. Accordingly, the optical system 1000 can be provided in a structure with a slim thickness.

Among the plurality of lens surfaces, the number of surfaces with an effective radius of less than 2 mm may be less than the number of surfaces with an effective radius of 2 mm or more, for example, may be less than 50% of the total lens surface. When the curvature radius is described as an absolute value, the curvature radius of the second surface S2 among the plurality of lenses 100A may be the largest among the lens surfaces, and may be a horizontal plane or infinity. When the focal length is described as an absolute value, the focal length of the fourth lens 115 among the plurality of lenses 100A may be the largest among the lenses, and may be more than 5 times the focal length of the seventh lens 117, for example, in a range of 5 to 20 times.

Table 2 is an example of lens data of the optical system of FIG. 8.

TABLE 2

| | | | Thickness | | | |
|---|---|---|---|---|---|---|
| | | Curvature | (mm)/ | Re- | | Effective |
| | | radius | Distance | fractive | Abbe | aperture |
| Lens | Surface | (mm) | (mm) | index | number | (mm) |
| Lens 1 | S1 | 2.594 | 0.770 | 1.564 | 38.930 | 3.576 |
| | S2 | | | | | |
| Lens 2 | S3 | infinity | 0.220 | 1.685 | 17.260 | 2.862 |
| | (Stop) | | | | | |
| | S4 | 8.456 | 0.900 | | | 2.579 |
| Lens 3 | S5 | −4.268 | 0.220 | 1.690 | 17.000 | 3.000 |
| | S6 | −5.875 | 0.020 | | | 3.362 |
| Lens 4 | S7 | 32.711 | 0.548 | 1.569 | 37.160 | 3.600 |
| | S8 | −64.299 | 0.260 | | | 4.073 |
| Lens 5 | S9 | 17.358 | 0.294 | 1.559 | 40.800 | 4.673 |
| | S10 | 3.877 | 0.232 | | | 5.089 |
| Lens 6 | S11 | 3.003 | 1.480 | 1.534 | 55.700 | 6.089 |
| | S12 | −2.798 | 0.935 | | | 6.910 |
| Lens 7 | S13 | −2.571 | 0.220 | 1.544 | 46.055 | 8.517 |
| | S14 | 4.253 | 0.669 | | | 9.256 |
| Filter | | Infinity | 0.230 | | | 10.379 |
| | | Infinity | 0.061 | | | 10.470 |
| Image | | Infinity | 0.040 | | | 10.542 |
| sensor | | | | | | |

Table 2 shows the curvature radius, the thickness of the lens, the distance between the lenses on the optical axis OA of the first to seventh lenses 111-117 of FIG. 1, the refractive index at d-line, Abbe Number, and effective aperture (CA: Clear aperture). As shown in FIG. 10, at least one of the plurality of lenses 100A in the first embodiment may include an aspheric surface with a 30th order aspherical coefficient. For example, the first to seventh lenses 111 to 117 may include a lens surface having a 30th order aspheric coefficient. As described above, an aspheric surface with a 30th order aspherical coefficient (a value other than “0”) can particularly significantly change the aspheric shape of the periphery portion, so the optical performance of the periphery portion of the FOV can be well corrected.

FIG. 12 is a graph of the diffraction MTF characteristics of the optical system 1000 according to the second embodiment, and FIG. 13 is a graph of the aberration characteristics. In the aberration graph in FIG. 13, longitudinal spherical aberration, astigmatic field curves, and distortion aberration are measured from left to right. In FIG. 13, X-axis may represent focal length (mm) and distortion (%), and the Y-axis may represent the height of the image. Additionally, the graph for astigmatism and distortion aberration is a graph for light in the about 555 nm wavelength band.

In the aberration diagram of FIG. 13, it may be interpreted that the closer each curve is to the Y-axis, the better the aberration correction function. Referring to FIG. 13, it may be seen that the measured values of the optical system 1000 according to the embodiment are adjacent to the Y-axis. That is, the optical system 1000 according to the embodiment may have improved resolution and good optical performance not only in the center portion of FOV but also in the periphery portion.

The optical system 1000 according to the first and second embodiments may satisfy at least one of the equations described below. Accordingly, the optical system 1000 according to the embodiment may have improved optical characteristics. For example, when the optical system 1000 satisfies at least one mathematical equation, the optical system 1000 can effectively control aberration characteristics such as chromatic aberration and distortion aberration, and may have good optical performance not only in the center portion of FOV but also in the periphery portion. Additionally, the optical system 1000 may have improved resolution and may have a slimmer and more compact structure. In addition, the meaning of the thickness of the lens in the optical axis OA, the distance in the optical axis OA of adjacent lenses, and the distance at the edge described in the equations may be the same as FIGS. 4 and 11.

$$2 < L1\_CT / L3\_CT < 5 \qquad [ Equation 1 ]$$

In Equation 1, L1_CT means the thickness (mm) at the optical axis OA of the first lens 101 and 111, and L3_CT means the thickness (mm) at the optical axis OA of the third lens 103 and 113. When the optical system 1000 according to the embodiment satisfies Equation 1, the optical system 1000 can improve aberration characteristics.

$$1 < L1\_CT / L1\_ET < 6 \qquad [ Equation 2 ]$$

In Equation 2, L1_ET means the thickness (mm) in the optical axis OA direction at the ends of the effective region of the first lens 101 and 111. In detail, L1_ET means the distance in the optical axis OA direction between the end of the effective region of the object-side first surface S1 and the end of the effective region of the sensor-side second surface S2 of the first lenses 101 and 111. If the optical system 1000 according to the embodiment satisfies Equation 1, the incident light ray can be controlled.

$$0.5 < L3\_CT / L3\_ET < 2 \qquad [ Equation 2 - 1 ]$$

In Equation 2-1, L3_CT means the thickness (mm) at the optical axis OA of the third lens 103 and 113, and L3_ET means a thickness (mm) in the optical axis OA direction at the end of the effective region of the third lens 103 and 113. In detail, L3_ET means a distance in the optical axis OA direction between the end of the effective region of the fifth surface S5 of the third lens 103 and 113 and the end of the effective region of the sixth surface S6 of the third lens 103 and 113. When the optical system 1000 according to the embodiment satisfies Equation 2-1, the optical system 1000 may have improved chromatic aberration control characteristics.

$$1 < L7\_ET / L7\_CT < 4 \qquad [ Equation 3 ]$$

In Equation 9, L7_CT means the thickness (mm) at the optical axis OA of the seventh lens 107 and 117, and L7_ET means the thickness (mm) in the optical axis OA direction at the end of the effective region of the seventh lens 107 and 117. In detail, L7_ET means a distance in the optical axis OA direction between the end of the effective region of the object-side surface S13 of the seventh lens 107 and 117 and the end of the effective region of the sensor-side surface S14 of the seventh lens 107 and 117. When the optical system 1000 according to the embodiment satisfies Equation 3, the optical system 1000 can reduce distortion and have improved optical performance.

$$1.6 < n 3 \qquad [ Equation 4 ]$$

In Equation 4, n3 means the refractive index at the d-line of the third lenses 103 and 113. When the optical system 1000 according to the embodiment satisfies Equation 4, the optical system 1000 can improve chromatic aberration characteristics.

$$1.45 < n 1 < 1.65 \qquad [ Equation 5 ]$$

In Equation 5, n1 means the refractive index at the d-line of the first lenses 101 and 111. When the optical system 1000 according to the embodiment satisfies Equation 5, the first lenses 101 and 111 have positive (+) refractive power, and by having a refractive index in the above range, the optical system 1000 may improve chromatic aberration characteristics.

$$1.55 < n 2 < 1.8 \qquad [ Equation 6 ]$$

In Equation 6, n2 means the refractive index at the d-line of the second lenses 102 and 112. When the optical system 1000 according to the embodiment satisfies Equation 6, the second lenses 102 and 112 have negative (−) refractive power, and by having a refractive index in the above range, the optical system 1000 may improve chromatic aberration characteristics.

$$0.05 < ( n 2 ) - ( n 1 ) < 0.25 \qquad [ Equation 7 ]$$

In Equation 7, when the difference in refractive index between the first lenses 101 and 111 and the second lenses 102 and 112 satisfies the above range, the optical system 1000 can improve chromatic aberration characteristics. In other words, chromatic aberration can be improved by using the difference in refractive index of the cemented lens.

$$10 < ( v 1 ) - ( v 2 ) < 50 \qquad [ Equation 8 ]$$

In Equation 8, if the difference between the Abbe number v1 of the first lens 101 and 111 and the Abbe number v2 of the second lens 102 and 112 satisfies the above range, the optical system 1000 can improve chromatic aberration characteristics. In other words, chromatic aberration can be improved by using the difference in Abbe number of the cemented lens.

$$0 \text{.5} < L 7 S 2 \_max \_sag to Sensor < 2 \qquad [ Equation 9 ]$$

In Equation 5, L7S2_max_sag to Sensor means the distance (mm) in the optical axis OA direction from the maximum Sag value of the sensor-side fourteenth surface S14 of the seventh lens 107 and 117 to the image sensor 300. For example, L7S2_max_sag to Sensor means the distance (mm) in the optical axis OA direction from the first inflection point P1 to the image sensor 300. When the optical system 1000 according to the embodiment satisfies Equation 9, the optical system 1000 secures a space where the filter 500 can be placed between the plurality of lenses 100 and 100A and the image sensor 300, thereby having improved assemblability. Additionally, if the optical system 1000 satisfies Equation 9, the optical system 1000 can secure a distance for module manufacturing.

In the lens data for the embodiment to be described later, the position of the filter, the distance between the last lens and the filter 500, and the distance between the image sensor 300 and the filter 500 are positions set for convenience in designing the optical system 1000, and the filter 500 can be freely arranged within a range that does not contact the two components 107 and 300, respectively. Accordingly, when the value of L7S2_max_sag to Sensor in the lens data is less than or equal to the distance in the optical axis OA between the object-side surface of the filter 500 and the image surface of the image sensor 300, BFL and L7S2_max_sag to Sensor in the optical system 1000 do not change and are constant, and the position of the filter 500 can be moved within a range that does not contact the two components 107 and 300, respectively, so that good optical performance can be achieved.

$$1 < BFL / L 10 S 2 \_max \_sag to Sensor < 2 \qquad [ Equation 10 ]$$

In Equation 10, the back focal length (BFL) means the distance (mm) in the optical axis OA from the center of the sensor-side fourteenth surface S14 of the seventh lenses 107 and 117 closest to the image sensor 300 to the image surface of the image sensor 300. The L7S2_max_sag to Sensor can use Equation 9. When the optical system 1000 according to the embodiment satisfies Equation 10, the optical system 1000 can improve distortion aberration characteristics and have good optical performance in the periphery portion of the FOV.

$$5 < \vert L 7 S 2 \_max slope \vert < 45 \qquad [ Equation 11 ]$$

In Equation 11, L7S2_max slope means the maximum value (Degree) of the tangential angle measured on the sensor-side fourteenth surface S14 of the seventh lens 107 and 117. In detail, L10S2_max slope in the fourteenth surface S14 means the angle value (Degree) of the point having the largest tangent angle with respect to an imaginary line extending in a direction perpendicular to the optical axis OA. When the optical system 1000 according to the embodiment satisfies Equation 11, the optical system 1000 can control the occurrence of lens flare.

$$0.2 < L 7 S 2 Inflection Point < 0.6 \qquad [ Equation 12 ]$$

In Equation 12, L7S2 Inflection Point may mean the position of the first inflection point P1 located on the sensor-side fourteenth surface S14 of the seventh lens 107 and 117. In detail, the L7S2 Inflection Point has the optical axis OA as the starting point, the end of the effective region of the fourteenth surface S14 of the seventh lens 107 and 117 as the end point, when the length of the optical axis OA in the vertical direction from the optical axis OA to the end of the effective area of the fourteenth surface S14 is 1, it may mean a position of the first inflection point P1 located on the fourteenth surface S14. When the optical system 1000 according to the embodiment satisfies Equation 8, the optical system 1000 can improve distortion aberration characteristics.

$$1 < L1\_CT / L7\_CT < 5 \qquad [ Equation 13 ]$$

In Equation 12, L1_CT means the thickness (mm) at the optical axis OA of the first lens 101 and 111, and L7_CT means the thickness (mm) at the optical axis OA of the seventh lens 107 and 117. When the optical system 1000 according to the embodiment satisfies Equation 12, the optical system 1000 may have improved aberration characteristics. Additionally, the optical system 1000 has good optical performance at a set FOV and can control TTL.

$$1 < L6\_CT / L7\_CT < 7 \qquad [ Equation 14 ]$$

In Equation 13, L6_CT means the thickness (mm) at the optical axis OA of the sixth lens 106 and 116, and L7_CT means the thickness (mm) at the optical axis OA of the seventh lens 107 and 117. When the optical system 1000 according to the embodiment satisfies Equation 14, the optical system 1000 can reduce the manufacturing precision of the sixth and seventh lenses, and may improve the optical performance of the center and periphery portions of the FOV.

$$0 < L 1 R 1 / L 7 R 2 < 1 \qquad [ Equation 15 ]$$

In Equation 15, L1R1 means the curvature radius (mm) of the first surface S1 of the first lens 101 and 111, and L7R2 means the curvature radius (mm) of the fourteenth surface S14 of the seventh lens 107 and 117. When the optical system 1000 according to the embodiment satisfies Equation 15, the aberration characteristics of the optical system 1000 may be improved.

$$0 < ( d67\_CT - d67\_ET ) / ( d67\_CT ) < 2 \qquad [ Equation 16 ]$$

In Equation 15, d67_CT means the optical axis distance (mm) between the sixth and seventh lenses 106 and 107, and d67_ET means the distance (mm) in the direction of the optical axis OA between the end of the effective region of the sensor-side twelfth surface S12 of the sixth lens 106 and 116 and the end of the effective region of the object-side thirteenth surface S13 of the seventh lens 107 and 117. When the optical system 1000 according to the embodiment satisfies Equation 16, distortion can be reduced and improved optical performance can be achieved. When the optical system 1000 according to the embodiment satisfies Equation 16, the optical system 1000 can reduce the manufacturing precision of the sixth and seventh lenses, and may improve optical performance in the center and periphery portions of the FOV.

$$1 < CA\_L1S1 / CA\_L2S1 < 1.5 \qquad [ Equation 17 ]$$

In Equation 16, CA_L1S1 means to the size (mm) of the effective aperture (CA) (H1 in FIG. 1) of the first surface S1 of the first lens 101 and 111, and CA_L2S1 means to the size (mm) of the effective aperture (CA) of the third surface S3 of the second lens 102 and 112. When the optical system 1000 according to the embodiment satisfies Equation 17, the optical system 1000 can control light incident on the first lens group G1 and have improved aberration control characteristics.

$$1 < CA\_L7S2 / CA\_L2S2 < 5 \qquad [ Equation 18 ]$$

In Equation 17, CA_L2S2 means the effective aperture of the fourth surface S4 of the second lens 102 and 112, and CA_L7S2 means the effective aperture of the fourteenth surface S14 of the seventh lens 107. When the optical system 1000 according to the embodiment satisfies Equation 18, the optical system 1000 can control light incident on the second lens group G2 and improve aberration characteristics.

$$0.2 < CA\_L2S2 / CA\_L3S1 < 1.5 \qquad [ Equation 19 ]$$

In Equation 19, CA_L2S2 means the effective aperture of the fourth surface S4 of the second lens 102 and 112, and CA_L3S1 means the effective aperture of the fifth surface S5 of the third lens 103 and 113. When the optical system 1000 according to the embodiment satisfies Equation 19, the optical system 1000 can improve chromatic aberration and control vignetting for optical performance.

$$0.1 < CA\_L5S2 / CA\_L7S2 < 1 \qquad [ Equation 20 ]$$

In Equation 20, CA_L5S2 means the effective aperture of the tenth surface S10 of the fifth lens 105, and CA_L7S2 means a size (mm) of the effective aperture (CA, H7 in FIG. 1) of the fourteenth surface S14 of the seventh lens 107. When the optical system 1000 according to the embodiment satisfies Equation 20, the optical system 1000 can improve chromatic aberration.

$$1 < d23\_CT / d23\_ET < 8 \qquad [ Equation 21 ]$$

In Equation 21, d23_CT means the distance (mm) between the second lenses 102 and 112 and the third lenses 103 and 113 in the optical axis OA. In detail, d23_CT means the distance (mm) in the optical axis OA between the third surface S3 of the second lens 102 and 112 and the fifth surface S5 of the third lens 103 and 113. d23_ET means to the distance (mm) in the optical axis direction between the ends of the effective regions of the third surface S3 of the second lens 102 and 112 and the fifth surface S5 of the third lens 103 and 113. When the optical system 1000 according to the embodiment satisfies Equation 21, the optical system 1000 can reduce chromatic aberration, improve aberration characteristics, and control vignetting for optical performance.

$$1 < d67\_CT / d23\_CT < 4 \qquad [ Equation 21 - 1 ]$$

d23_CT means the distance (mm) in the optical axis between the second and third lenses, and d67_CT means the distance (mm) on the optical axis between the sixth and seventh lenses. When the optical system 1000 according to the embodiment satisfies Equation 21-1, the optical system 1000 can reduce chromatic aberration, improve aberration characteristics, and may control vignetting for optical performance.

$$1 < d67\_CT / d67\_ET < 3 \qquad [ Equation 22 ]$$

In Equation 21, d910_CT means the distance (mm) between the sixth and seventh lenses 106 and 107 in the optical axis OA. In detail, d67_CT means the distance (mm) in the optical axis OA between the twelfth surface S12 of the sixth lens 106 and 116 and the thirteenth surface S13 of the seventh lens 107 and 117. d67_ET means the distance (mm) in the optical axis OA direction between the end of the effective region of the twelfth surface S12 of the sixth lens 106 and 116 and the end of the effective region of the thirteenth surface S13 of the seventh lens 107 and 117. When the optical system 1000 according to the embodiment satisfies Equation 22, good optical performance can be achieved even in the center and periphery portions of the FOV, and distortion can be suppressed.

$$0 < d67\_max / d67\_CT < 2 \qquad [ Equation 23 ]$$

In Equation 23, d67_Max means the maximum distance among the distances (mm) between the sixth and seventh lenses 106 and 107. In detail, d67_Max means the maximum distance between the twelfth surface S12 of the sixth lens 109 and the thirteenth surface S13 of the seventh lens 107. When the optical system 1000 according to the embodiment satisfies Equation 23, optical performance can be improved in the periphery portion of the FOV, and distortion of aberration characteristics can be suppressed. Additionally, the relationship between the distance between the sixth lens 106 and 116 and the seventh lens 107 and 117 and the distance between the first lens 101 and 111 and the second lens 102 and 112 may satisfy the following equation.

$$d67\_CT = ( d67\_CT / d12\_CT ) \qquad ( Equation 23 - 1 )$$

$$d67\_Max = ( d67\_CT / d12\_CT ) \qquad ( Equation 23 - 2 )$$

$$d67\_Min < ( d67\_CT / d12\_CT ) \qquad ( Equation 23 - 3 )$$

In Equations 23-1, 2, and 3, d12_CT means the distance (mm) in the optical axis between the first lens 101 and the second lens 102. d67_CT means the distance (mm) in the optical axis between the sixth lens 106 and the seventh lens 107, and d67_Min means the minimum distance (mm) between the sixth lens 106 and the seventh lens 107. When the optical system 1000 according to the embodiment satisfies Equations 23-1, 2, and 3, the optical system 1000 can improve aberration characteristics and may control to reduce the size of the optical system 1000, for example, TTL. Additionally, the distance between the first and second lenses and the first and second groups may satisfy the following equation.

$$dG12\_CT = ( dG12\_CT / d12\_CT ) \qquad ( Equation 23 - 4 )$$

$$dG12\_Max = ( dG12\_CT / d12\_CT ) \qquad ( Equation 23 - 5 )$$

$$dG12\_Min < ( dG12\_CT / d12\_CT ) \qquad ( Equation 23 - 6 )$$

Here, dG12_CT means the distance in the optical axis between the first and second lens groups G1 and G2, dG12_Max means the maximum distance among the distances between the first and second lens groups G1 and G2, and dG12_Min means the minimum distance between the first and second lens groups G1 and G2. d12_CT means the distance in the optical axis between the first lens 101 and the second lens 102.

$$0.1 < L6\_CT / d67\_CT < 1 \qquad [ Equation 24 ]$$

In Equation 24, L6_CT means the thickness (mm) of the sixth lens 106 and 116 at the optical axis OA, and d67_CT means the distance (mm) between the sixth and seventh lenses 106 and 107 in the optical axis OA. When the optical system 1000 according to the embodiment satisfies Equation 24, the optical system 1000 reduces the effective aperture size of the sixth lens 106 and 116 and the center distance between the sixth and seventh lenses 106 and 107, and may improve the optical performance of the periphery portion of the FOV.

$$0.01 < L7\_CT / d67\_CT < 1 \qquad [ Equation 25 ]$$

In Equation 25, L7_CT means the thickness (mm) of the seventh lens 107 and 117 at the optical axis OA, and d67_CT mans the distance (mm) between the sixth and seventh lenses 106 and 107 in the optical axis OA. When the optical system 1000 according to the embodiment satisfies Equation 25, the optical system 1000 reduces the effective aperture size of the seventh lens 107 and 117 and the center distance between the sixth and seventh lenses 106 and 107, may improve the optical performance of the periphery portion of the FOV.

$$1 < \vert L 5 R 1 / L5\_CT \vert < 100 \qquad [ Equation 26 ]$$

In Equation 26, L5R1 means the curvature radius (mm) of the ninth surface S9 of the fifth lens 105 and 115, and L5_CT means the thickness (mm) of the fifth lens 105 and 115 at the optical axis. When the optical system 1000 according to the embodiment satisfies Equation 26, the optical system 1000 may control the refractive power of the fifth lens 105 and 115 and improve the optical performance of the light incident on the second lens group G2.

$$1 < \vert L 5 R 1 / L 7 R 1 \vert < 20 \qquad [ Equation 27 ]$$

In Equation 27, L7R1 means the curvature radius (mm) of the thirteenth surface S13 of the seventh lens 107 and 117. When the optical system 1000 according to the embodiment satisfies Equation 27, the shape and refractive power of the fifth and seventh lenses 105 and 107 can be controlled to improve optical performance, and the optical performance of the second lens group G2 can be improved.

$$0 < L\_CT \_Max / Air\_Max < 2 \qquad [ Equation 28 ]$$

In Equation 28, L_CT_max refers to the thickest thickness (mm) at the optical axis OA of each of the plurality of lenses, and Air_max means the maximum value of the air gaps or distances (mm) between the plurality of lenses. When the optical system 1000 according to the embodiment satisfies Equation 28, the optical system 1000 has good optical performance at the set FOV and focal length, and the optical system 1000 can be reduced in size, for example, reducing TTL.

$$0.5 < \sum L\_CT / \sum Air\_CT < 2 \qquad [ Equation 29 ]$$

In Equation 29, ΣL_CT means the sum of the thicknesses (mm) of each of the plurality of lenses at the optical axis OA, and ΣAir_CT means the sum of the thicknesses (mm) between two adjacent lenses in the plurality of lenses in the optical axis OA. When the optical system 1000 according to the embodiment satisfies Equation 29, the optical system 1000 has good optical performance at the set FOV and focal length, and the optical system 1000 can be reduced in size, for example, reducing TTL.

$$10 < \sum Index < 30 \qquad [ Equation 30 ]$$

In Equation 30, ΣIndex means the sum of the refractive indices at the d-line of each of the plurality of lenses 100 and 100A. When the optical system 1000 according to the embodiment satisfies Equation 30, TTL of the optical system 1000 can be controlled and improved resolution can be achieved.

$$10 < \sum Abb / \sum Index < 50 \qquad [ Equation 31 ]$$

In Equation 31, ΣAbb means the sum of the Abbe numbers of each of the plurality of lenses 100 and 100A. When the optical system 1000 according to the embodiment satisfies Equation 31, the optical system 1000 may have improved aberration characteristics and resolution.

$$0.01 > d12\_CT - d12\_ET \qquad [ Equation 32 ]$$

In Equation 32, d12_CT means the distance (mm) in the optical axis between the first lenses 101 and 111 and the second lenses 102 and 112, and d12_ET means the distance in the optical axis direction between the ends of the effective regions between the first lenses 101 and 111 and the second lenses 102 and 112. When the optical system 1000 according to the embodiment satisfies Equation 32, it can have a cemented lens, improve distortion aberration, and provide a slim optical system.

$$30 < L 12 \_CT / L12\_ET \qquad [ Equation 32 - 1 ]$$

In Equation 32-1, L12_CT means the distance in the optical axis from the object-side surface of the first lens 101 and 111 to the sensor-side surface of the second lens 102 and 112, and L12_ET means the distance in the optical axis OA direction between the end of the object-side surface of the first lens 101 and 111 and the end of the effective region of to the end of the effective region of the sensor-side surface of the second lens 102 and 112. In the first embodiment, Equation 32-1 may be 30 or more or 50 or more, for example, in the range of 50 to 100, and in the second embodiment, Equation 32-1 may be 30 or more, for example, in the range of 30 to 55. When the optical system 1000 according to the embodiment satisfies Equation 32-1, it can have a cemented lens, improve distortion aberration, and provide a slim optical system.

$$0 < Air\_ET \_Max / L\_CT \_Max < 3 \qquad [ Equation 33 ]$$

In Equation 33, L_CT_max means the thickest thickness (mm) among the thicknesses at the optical axis OA of each of the plurality of lenses, and Air_CT_Max means the distance in the optical axis OA direction between the end of the effective region of the sensor-side surface of the n-lth lens facing each other and the end of the effective region of the object-side surface of the n-th lens among the two lenses adjacent to the image sensor 300, as shown in FIGS. 2 and 9, and for example, means the maximum value (Air_Edge_max) of the edge distances between the two lenses. In other words, it means the largest value among d(n−1, n)_ET values in the lens data to be described later (where n is a natural number greater than 1 and less than or equal to 7). When the optical system 1000 according to the embodiment satisfies Equation 33, the optical system 1000 has a set FOV and focal length, and can have good optical performance in the periphery portion of the FOV.

$$0.5 < CL\_L1S1 / CA\_min < 2 \qquad [ Equation 34 ]$$

In Equation 34, CA_L1S1 means the effective aperture (mm) of the first surface (S1) of the first lens 101 and 111, and CA_Min means the smallest effective diameter among the effective aperture (mm) of the lens surfaces of the lenses. When the optical system 1000 according to the embodiment satisfies Equation 34, light incident through the first lenses 101 and 111 can be controlled, and a slim optical system can be provided while maintaining optical performance.

$$1 < CA\_max / CA\_min < 5 \qquad [ Equation 35 ]$$

In Equation 35, CA_max means the largest effective aperture (mm) among the object-side surfaces and the sensor-side surfaces of the plurality of lenses, and the largest effective aperture among the effective aperture (mm) of the lens surfaces. When the optical system 1000 according to the embodiment satisfies Equation 35, the optical system 1000 can provide a slim and compact optical system while maintaining optical performance.

$$2 \leq AVR\_CA \_L7 / AVR\_CA \_L2 < 4 \qquad [ Equation 35 - 1 ]$$

In Equation 35-1, AVR_CA_L7 means the average value of the effective aperture (mm) of the thirteenth and fourteenth surfaces S13 and S14 of the seventh lens 107 and 117, and is the average value of the effective aperture (mm) of the two largest lens surfaces among the lenses. The AVR_CA_L2 represents the average value of the effective aperture (mm) of the second and third surfaces S2 and S3 of the second lenses 102 and 112, and represents the average of the effective apertures of the two smallest lens surfaces among the lenses. That is, the difference in the average effective aperture of the object-side and sensor-side surfaces S3 and S4 of the last lens L2 of the first lens group G1 and the average effective aperture of the object-side and sensor-side surfaces S13 and S14 of the last lens L7 of the second lens group G2 may be the largest. When the optical system 1000 according to the embodiment satisfies Equation 35-1, the optical system 1000 can provide a slim and compact optical system while maintaining optical performance.

Using these equations 35 and 35-1, the effective aperture CA_L7S1 of the thirteenth surface S13 of the seventh lens 107 and 117 can be twice or more the minimum effective aperture CA_min, and the effective aperture CA_L7S2 of the fourteenth surface S14 may be twice or more the minimum effective aperture CA_min. In other words, the following equation can be satisfied.

$$2 \leq CA\_L7S1 / CA\_min < 5 \qquad ( Equation 35 - 2 )$$

$$2 \leq CA\_L7S2 / CA\_min < 5 \qquad ( Equation 35 - 3 )$$

Using these equations 35, 35-1 to 35-3, the effective aperture CA_L7S2 of the thirteenth surface S13 of the seventh lens 107 and 117 may be twice or more the average effective aperture AVR_CA_L3 of the second lens 102 and 112, for example, in the range of 2 to 4 times, and the effective aperture CA_L7S2 of the fourteenth surface S14 may be twice or more the average effective aperture AVR_CA_L3 of the second lenses 102 and 112, for example, in the range of 2 times more and less than 5 times.

In other words, the following equation can be satisfied.

$$2 \leq CA\_L7S1 / AVR\_CA \_L 2 \leq 4 \qquad ( Equation 35 - 4 )$$

$$2 \leq CA\_L7S2 / AVR\_CA \_L2 < 5 \qquad ( Equation 35 - 5 )$$

$$1 < CA\_max / CA\_Aver < 3 \qquad [ Equation 36 ]$$

In Equation 36, CA_max means the largest effective aperture (mm) among the object-side surfaces and the sensor-side surfaces of the plurality of lenses, and CA_Aver means the average effective aperture (mm) of the object-side surfaces and the sensor-side surfaces of the plurality of lenses. When the optical system 1000 according to the embodiment satisfies Equation 36, a slim and compact optical system can be provided.

$$0.1 < CA\_min / CA\_Aver < 1 \qquad [ Equation 37 ]$$

In Equation 37, CA_min means the smallest effective aperture (mm) among the object-side surfaces and the sensor-side surfaces of the plurality of lenses. When the optical system 1000 according to the embodiment satisfies Equation 37, a slim and compact optical system can be provided.

$$0.1 < CA\_max / ( 2 * ImgH ) < 1 \qquad [ Equation 38 ]$$

In Equation 38, CA_max means the largest effective aperture among the object-side surfaces and the sensor-side surfaces of the plurality of lenses, and ImgH refers to a distance (mm) from the center (0.0F) of the image sensor 300 to the diagonal end (1.0F) overlapping the optical axis OA. That is, the ImgH means ½ of the maximum diagonal length (mm) of the effective region of the image sensor 300. When the optical system 1000 according to the embodiment satisfies Equation 38, the optical system 1000 has good optical performance in the center and periphery portions of the FOV and can provide a slim and compact optical system.

$$0.5 < TD / CA\_max < 1.5 \qquad [ Equation 39 ]$$

In Equation 39, TD is the maximum optical axis distance (mm) from the object-side surface of the first lens group G1 to the sensor-side surface of the second lens group G2. For example, it is the distance from the first surface S1 of the first lens 101 to the fourteenth surface S14 of the seventh lens 107 and 117 in the optical axis OA. When the optical system 1000 according to the embodiment satisfies Equation 39, a slim and compact optical system can be provided.

$$1 < F / L 7 R 2 < 10 \qquad [ Equation 40 ]$$

In Equation 40, F means the total focal length (mm) of the optical system 1000, and L7R2 means the curvature radius (mm) of the fourteenth surface S14 of the seventh lens 107 and 117. When the optical system 1000 according to the embodiment satisfies Equation 40, the optical system 1000 can reduce the size of the optical system 1000, for example, reduce the TTL.

$$1 < F / L 1 R 1 < 10 \qquad [ Equation 41 ]$$

In Equation 41, L1R1 means the curvature radius (mm) of the first surface S1 of the first lens 101. When the optical system 1000 according to the embodiment satisfies Equation 41, the optical system 1000 can reduce the size of the optical system 1000, for example, reduce the TTL.

$$0.1 < EPD / L 7 R 2 < 5 \qquad [ Equation 42 ]$$

In Equation 42, EPD means the size (mm) of the entrance pupil diameter of the optical system 1000, and L7R2 means the curvature radius (mm) of the fourteenth surface S14 of the seventh lens 107. When the optical system 1000 according to the embodiment satisfies Equation 42, the optical system 1000 can control the overall brightness and have good optical performance in the center and periphery portions of the FOV.

$$0.5 < EPD / L 1 R 1 < 8 \qquad [ Equation 43 ]$$

Equation 42 represents the relationship between the size of the EPD of the optical system and the curvature radius of the first surface S1 of the first lens 101, and can control incident light.

$$- 3 < \vert f 1 / f 3 \vert < 0 \qquad [ Equation 44 ]$$

In Equation 44, f1 means the focal length (mm) of the first lens 101, and f3 means the focal length (mm) of the third lens 103. When the optical system 1000 according to the embodiment satisfies Equation 44, the first lens 101 and the third lens 103 can have appropriate refractive power for controlling the incident light path and can improve resolution.

$$1 < f 12 / F < 5 \qquad [ Equation 45 ]$$

In Equation 45, f12 means the composite focal length (mm) of the first to second lenses 101 to 102, and F means the total focal length (mm) of the optical system 1000. Equation 45 establishes the relationship between the focal length of the first lens group G1 and the total focal length. When the optical system 1000 according to the embodiment satisfies Equation 45, the optical system 1000 can control TTL.

$$0 < \vert f 37 / f 12 \vert < 20 \qquad [ Equation 46 ]$$

In Equation 46, f12 means the composite focal length (mm) of the first and second lenses 101 and 102, and f37 means the composite focal length (mm) of the third to seventh lenses 103 to 107. Equation 46 establishes the relationship between the focal length of the first lens group G1 and the focal length of the second lens group G2. In an embodiment, the composite focal length of the first to second lenses 101 and 102 may have a positive (+) value, and the composite focal length of the third to seventh lenses 103 to 107 may have a negative (−) value. When the optical system 1000 according to the embodiment satisfies Equation 46, the optical system 1000 can improve aberration characteristics such as chromatic aberration and distortion aberration.

$$2 < TTL < 20 \qquad [ Equation 47 ]$$

In Equation 47, TTL means the distance (mm) in the optical axis OA from the apex of the first surface S1 of the first lens 101 to the image surface of the image sensor 300. By setting the TTL to less than 20 mm in Equation 47, a slim and compact optical system can be provided.

$$2 < ImgH \qquad [ Equation 48 ]$$

Equation 48 allows the diagonal size of the image sensor 300 to exceed 2 mm, thereby providing an optical system with high resolution.

$$BFL < 2.5 \qquad [ Equation 49 ]$$

Equation 42 sets the BFL (Back focal length) to less than 2.5 mm, thereby securing an installation space of the filter 500, improving the assemblability of components through the distance between the image sensor 300 and the last lens, and improving coupling reliability.

$$2 < F < 20 \qquad [ Equation 50 ]$$

In Equation 50, the total focal length F can be set to suit the optical system.

$$FOV < 120 \qquad [ Equation 51 ]$$

In Equation 51, FOV (Field of view) refers to the angle of view (Degree) of the optical system 1000, and can provide an optical system of less than 120 degrees. The FOV may range from 80±5 degrees.

$$0.5 < TTL / CA\_max < 2 \qquad [ Equation 52 ]$$

In Equation 52, CA_max refers to the largest effective aperture (mm) among the object-side surfaces and the sensor-side surfaces of the plurality of lenses, and TTL means the distance (mm) in the optical axis OA from the apex of the first surface S1 of the first lens 101 and 111 to the image surface of the image sensor 300. Equation 52 sets the relationship between the total optical axis length of the optical system and the maximum effective diameter, thereby providing a slim and compact optical system.

$$0.4 < TTL / ImgH < 3 \qquad [ Equation 53 ]$$

Equation 53 can set the total optical axis length (TTL) of the optical system and the diagonal length (ImgH) of the image sensor 300 from the optical axis. When the optical system 1000 according to the embodiment satisfies Equation 53, the optical system 1000 secures a back focal length (BFL) for applying a relatively large image sensor 300, for example, a large image sensor 300 of about 1 inch, and may have a smaller TTL, thereby having a high-definition implementation and a slim structure.

$$0.6 < TTL / IH < 0.8 \qquad [ Equation 53 - 1 ]$$

In Equation 53-1, TTL is the optical axis distance from the object-side surface of the first lens 101 and 111 to the image sensor 300, and IH means to the diagonal length (mm) of the image sensor 300. That is, the IH represents 2*ImgH. When the optical system 1000 according to the embodiment satisfies Equations 53 and 53-1, the optical system 1000 has good optical performance in the center and periphery portions of the FOV and can provide a slim and compact optical system. Here, * is multiplication.

$$0.01 < BFL / ImgH < 0.5 \qquad [ Equation 54 ]$$

Equation 54 can set the optical axis distance between the image sensor 300 and the last lens and the diagonal length from the optical axis of the image sensor 300. When the optical system 1000 according to the embodiment satisfies Equation 54, the optical system 1000 may secure a back focal length (BFL) for applying a relatively large image sensor 300, for example, a large image sensor 300 of about 1 inch, and may minimize the distance between the last lens and the image sensor 300, thereby having good optical properties at the center and periphery of the angle of view FOV.

$$4 < TTL / BFL < 10 \qquad [ Equation 55 ]$$

Equation 55 can set (unit, mm) the total optical axis length (TTL) of the optical system and the optical axis length (BFL) between the image sensor 300 and the last lens. When the optical system 1000 according to the embodiment satisfies Equation 55, the optical system 1000 secures BFL and can be provided in a slim and compact manner.

$$0.5 < F / TTL < 1.5 \qquad [ Equation 56 ]$$

Equation 56 can set the total focal length (F) and total optical axis length (TTL) of the optical system 1000. Accordingly, a slim and compact optical system can be provided.

$$3 < F / BFL < 10 \qquad [ Equation 57 ]$$

Equation 57 can set (unit, mm) the total focal length (F) of the optical system 1000 and the optical axis length (BFL) between the image sensor 300 and the last lens. When the optical system 1000 according to the embodiment satisfies Equation 57, the optical system 1000 can have a set angle of view and an appropriate focal distance, and a slim and compact optical system can be provided. In addition, the optical system 1000 can minimize the distance between the last lens and the image sensor 300 and thus have good optical characteristics in the periphery portion of the FOV.

$$0.1 < F / ImgH < 1 \qquad [ Equation 58 ]$$

Equation 58 can set the total focal length (F, mm) of the optical system 1000 and the diagonal length (ImgH) of the image sensor 300 from the optical axis. This optical system 1000 uses a relatively large image sensor 300, for example, around 1 inch, and may have improved aberration characteristics.

$$1 \leq F / EPD < 5 \qquad [ Equation 59 ]$$

Equation 59 can set the total focal length (F, mm) and the EPD of the optical system 1000. Accordingly, the overall brightness of the optical system can be controlled.

$$Z = \frac{{cr}^{2}}{1 + \sqrt{1 - ( 1 + k ) {c}^{2} {r}^{2}}} + {u}^{4} {\sum }_{m = 0}^{13} {a}_{m} {Q}_{m}^{con} ( {u}^{2} ) \qquad [ Equation 60 ]$$

The meaning of each item in Equation 60 is as follows.
Z: The sag of the surface parallel to the Z-axis (in lens units)
c: The vertex curvature (CUY)
k: The conic constant
r: The radial distance
rn: The normalization radius (NRADIUS)
u:r/rn
aₘ: The m^{th}Q^{con} coefficient, which correlates to surface sag departure
Qₘ^{con}: The m^{th}Q^{con} polynomial

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 61 ]$$

In Equation 61, Z is Sag and can mean the distance in the optical axis direction from any position on the aspherical surface to the apex of the aspherical surface. The Y may refer to the distance from any location on the aspherical surface to the optical axis in a direction perpendicular to the optical axis. The c may refer to the curvature of the lens, and K may refer to the Conic constant. Additionally, A, B, C, D, E, and F may mean aspheric constants.

The optical system 1000 according to the embodiment may satisfy at least one or two of Equations 1 to 59. In this case, the optical system 1000 may have improved optical characteristics. In detail, when the optical system 1000 satisfies at least one or two of Equations 1 to 59, the optical system 1000 has improved resolution and can improve aberration and distortion characteristics. In addition, the optical system 1000 can secure a back focal length (BFL) for applying a large-sized image sensor 300, and can minimize the distance between the last lens and the image sensor 300, thereby having good optical performance in the center and periphery portions of the FOV. In addition, when the optical system 1000 satisfies at least one of Equations 1 to 59, it may include an image sensor 300 of a relatively large size, have a relatively small TTL value, and be slimmer.

A compact optical system and a camera module having the same can be provided. In the optical system 1000 according to the embodiment, the distance between the plurality of lenses 100 may have a value set according to the regions. Table 3 shows the items of the above-described equations in the optical system 1000 according to the first and second embodiments, and shows TTL, BFL (Back focal length) of the optical system 1000, a value of F (total focal length), ImgH, focal lengths f1, f2, f3, f4, f5, f6, and f7 of each of the first to ninth lenses, composite focal length, ET (Edge thickness), etc. Here, the edge thickness of the lens refers to the thickness in the optical axis direction Z at the end of the effective region of the lens, and the unit is mm.

TABLE 3

| Items | First embodiment | Second embodiment |
|---|---|---|
| F | 5.200 | 5.200 |
| f1 | 6.000 | 7.743 |
| f2 | 8.102 | −12.209 |
| f3 | −13.431 | −23.710 |
| f4 | −23.749 | 38.008 |
| f5 | 21.360 | −8.955 |
| f6 | −13.399 | 2.970 |
| f7 | 4.034 | −2.899 |
| f12(f_G1) | 7.0345 | 6.77 |
| f37(f_G2) | −23.7032 | −90.73 |
| L1_ET | 0.253 | 0.220 |
| L2_ET | 0.352 | 0.323 |
| L3_ET | 0.420 | 0.378 |
| L4_ET | 0.443 | 0.224 |
| L5_ET | 0.365 | 0.200 |
| L6_ET | 0.499 | 0.274 |
| L7_ET | 1.479 | 0.607 |
| d12_ET | 0.0000 | 0.0000 |
| d23_ET | 0.3622 | 0.4943 |
| d34_ET | 0.0865 | 0.0338 |
| d45_ET | 0.5386 | 0.3794 |
| d56_ET | 0.2789 | 0.2938 |
| d67_ET | 0.3336 | 0.7563 |
| EPD | 3.333 | 2.886 |
| BFL | 1.042 | 1.00 |
| TD | 7.034 | 6.769 |
| Imgh | 5.296 | 5.271 |
| TTL | 7.771 | 7.10 |
| F-number | 1.877 | 1.802 |
| FOV | 80.79 degrees | 88 degrees |

Table 4 shows the result values for Equations 1 to 59 described above in the optical system 1000 of FIG. 1. Referring to Table 4, it can be seen that the optical system 1000 satisfies at least one, two, or three of Equations 1 to 59. In detail, it can be seen that the optical system 1000 according to the embodiment satisfies all of Equations 1 to 59 above. Accordingly, the optical system 1000 can improve optical performance and optical characteristics in the center and periphery portions of the FOV.

TABLE 4

| | | First | Second |
|---|---|---|---|
| Equations | | embodiment | embodiment |
| 1 | 2 < L1_CT/L3_CT < 5 | 3.71 | 3.50 |
| 2 | 1 < L1_CT/L1_ET < 5 | 3.73 | 3.50 |
| 3 | 1 < L7_ET/L7_CT < 4 | 3.05 | 2.76 |
| 4 | 1.6 < n3 | 1.690 | 1.690 |
| 5 | 1.45 < n1 < 1.65 | 1.55 | 1.56 |
| 6 | 1.55 < n2 < 1.8 | 1.659 | 1.685 |
| 7 | 0.05 < (n2) − (n1) < 0.25 | 0.111 | 0.121 |
| 8 | 10 < (v1) − (v2) < 50 | 24.038 | 21.670 |
| 9 | 0.5 < L7S2_max_sag to Sensor < 2 | 0.884 | 0.850 |
| 10 | 1 < BFL/L7S2_Max_sag to sensor < 2 | 1.178 | 1.176 |
| 11 | 5 < \|L7S2_max slope\| < 45 | 31.59 | 47.43 |
| 12 | 0.2 < L7S2 Inflection Point < 0.6 | 0.49 | 0.39 |
| 13 | 1 < L1_CT/L7_CT < 5 | 1.942 | 3.501 |
| 14 | 1 < L6_CT/L7_CT < 7 | 2.281 | 6.727 |
| 15 | 0 < L1R1/L7R2 < 1 | 0.462 | 0.610 |
| 16 | 0 < (d67_CT − | 0.624 | 0.191 |
| | d67_ET)/(d67_CT) < 2 | | |
| 17 | 1 < CA_L1S1/CA_L2S2 < 1.5 | 1.220 | 1.387 |
| 18 | 1 < CA_L7S2/CA_L2S2 < 5 | 3.009 | 3.590 |
| 19 | 0.2 < CA_L2S2/CA_L3S1 < 1.5 | 0.945 | 0.860 |
| 20 | 0.1 < CA_L5S2/CA_L7S2 < 1 | 0.593 | 0.550 |
| 21 | 1 < d23_CT/d23_ET < 8 | 2.056 | 1.821 |
| 22 | 1 < d67_CT/d67_ET < 3 | 2.662 | 1.236 |
| 23 | 0 < d67_max/d67_CT < 2 | 1.000 | 1.000 |
| 24 | 0.1 < L6_CT/d67_CT < 1 | 1.246 | 1.583 |
| 25 | 0.01 < L7_CT/d67_CT < 1 | 0.546 | 0.235 |
| 26 | 1 < \|L5R1/L5_CT\| < 100 | 85.212 | 59.027 |
| 27 | 1 < \|L5R1/L7R1\| < 20 | 13.641 | 6.750 |
| 28 | 0 < L_CT_Max/Air_Max < 2 | 1.246 | 1.583 |
| 29 | 0.5 < ΣL_CT/ΣAir_CT < 2 | 1.780 | 1.598 |
| 30 | 10 < ΣIndex < 30 | 11.137 | 11.146 |
| 31 | 10 < ΣAbb/ΣIndex < 50 | 21.662 | 22.691 |
| 32 | 0.01 > d12_CT − d12_ET | 0 | 0 |
| 33 | 0 < Air_ET_Max/L_CT_Max < 3 | 2.265 | 1.323 |
| 34 | 0.5 < CA_L1S1/CA_min < 2 | 1.220 | 1.387 |
| 35 | 1 < CA_max/CA_min < 5 | 3.009 | 3.590 |
| 36 | 1 < CA_max/CA_Aver < 3 | 1.838 | 1.892 |
| 37 | 0.1 < CA_min/CA_Aver < 1 | 0.611 | 0.527 |
| 38 | 0.1 < CA_max/(2*ImgH) < 1 | 0.833 | 0.878 |
| 39 | 0.5 < TD/CA_max < 1.5 | 0.797 | 0.731 |
| 40 | 1 < F/L7R2 < 10 | 1.031 | 1.223 |
| 41 | 1 < F/L1R1 < 10 | 2.233 | 2.005 |
| 42 | 0 < EPD/L7R2 < 5 | 0.573 | 0.678 |
| 43 | 0.5 < EPD/L1R1 < 8 | 1.241 | 1.112 |
| 44 | 0 < \|f1/f3\| < 3 | 0.341 | 0.327 |
| 45 | 1 < f12/F < 5 | 1.172 | 1.301 |
| 46 | 0 < \|f37/f12\| < 20 | 3.370 | 13.409 |
| 47 | 2 < TTL < 20 | 6.000 | 5.200 |
| 48 | 2 < ImgH | 5.296 | 5.271 |
| 49 | BFL < 2.5 | 1.042 | 1.000 |
| 50 | 2 < F < 20 | 6.000 | 5.200 |
| 51 | FOV < 120 | 80.791 | 88.000 |
| 52 | 0.5 < TTL/CA_max < 2 | 0.881 | 0.767 |
| 53 | 0.4 < TTL/ImgH < 2.5 | 1.467 | 1.347 |
| 54 | 0.01 < BFL/ImgH < 0.5 | 0.197 | 0.190 |
| 55 | 4 < TTL/BFL < 10 | 7.459 | 7.100 |
| 56 | 0.5 < F/TTL < 1.5 | 0.772 | 0.732 |
| 57 | 3 < F/BFL < 10 | 5.760 | 5.200 |
| 58 | 0.1 < F/ImgH < 1.5 | 1.133 | 0.987 |
| 59 | 1 < F/EPD < 5 | 1.800 | 1.802 |

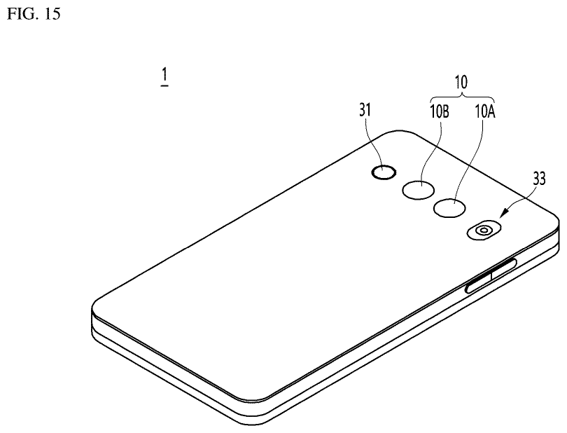

FIG. 15 is a diagram illustrating a camera module according to an embodiment applied to a mobile terminal. Referring to FIG. 15, the mobile terminal 1 may include a camera module 10 provided at the rear. The camera module 10 may include an image capturing function. Additionally, the camera module 10 may include at least one of an auto focus, zoom function, and OIS function. The camera module 10 can process image frames of still images or videos obtained by the image sensor 300 in shooting mode or video call mode. The processed image frame may be displayed on a display unit (not shown) of the mobile terminal 1 and may be stored in a memory (not shown). In addition, although not shown in the drawing, the camera module may be further disposed on the front of the mobile terminal 1. For example, the camera module 10 may include a first camera module 10A and a second camera module 10B. At this time, at least one of the first camera module 10A and the second camera module 10B may include the optical system 1000 disclosed above. Accordingly, the camera module 10 can have a slim structure and have improved distortion and aberration characteristics. Additionally, the camera module 10 can have good optical performance even in the center and periphery portions of the FOV.

Additionally, the mobile terminal 1 may further include an autofocus device 31. The autofocus device 31 may include an autofocus function using a laser. The autofocus device 31 can be mainly used in conditions where the autofocus function using the image of the camera module 10 is deteriorated, for example, in close proximity of 10 m or less or in dark environments. The autofocus device 31 may include a light emitting unit including a vertical cavity surface emitting laser (VCSEL) semiconductor device, and a light receiving unit such as a photo diode that converts light energy into electrical energy. The mobile terminal 1 may further include a flash module 33. The flash module 33 may include a light emitting device inside that emits light. The flash module 33 can be operated by operating a camera of a mobile terminal or by user control.

Features, structures, effects, etc. described in the above embodiments are included in at least one embodiment of the invention, and are not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It can be seen that various modifications and applications that have not been made are possible. For example, each component specifically shown in the embodiment can be implemented by modification. And the differences related to these modifications and applications should be construed as being included in the scope of the invention defined in the appended claims.

1. An optical system comprising:
first to seventh lenses disposed along an optical axis from an object side toward a sensor side,
wherein the first lens has positive (+) refractive power on the optical axis,
wherein the second lens has negative (−) refractive power on the optical axis,
wherein the seventh lens has negative (−) refractive power on the optical axis,
wherein an object-side surface of the first lens has a convex shape on the optical axis,
wherein a sensor-side surface of the first lens is bonded to the second lens,
wherein a sensor-side surface of the seventh lens has a largest effective aperture among the first to seventh lenses,
wherein a composite focal length of the first to second lenses has a positive (+) value,
wherein a distance in the optical axis from an apex of the object-side surface of the first lens to an image surface of an image sensor is TTL, ½ of a maximum diagonal length of the image sensor is ImgH, a refractive index of the first lens is n1, and a refractive index of the second lens is n2, and
wherein the following equation satisfy: 0.4<TTL/ImgH<3
$$0.05 < ( n 2 ) - ( n 1 ) < 0.25 .$$

2. The optical system of claim 1, wherein a refractive index of the third lens has n3, and the refractive indices of the first, second, and third lenses satisfy the following equation:
1.45<n1<1.65
1.55<n2<1.8
1.6<n3.

3. The optical system of claim 1, wherein Abbe numbers of the first and second lenses are v1 and v2, and satisfy the following equation:
$$10 < ( v 1 ) - ( v 2 ) < 50 .$$

4. The optical system of claim 1, wherein a thickness of the first lens at the optical axis is L1_CT, a thickness of the third lens at the optical axis is L3_CT, and a largest effective aperture among effective apertures of object-side surfaces and sensor-side surfaces of the first to seventh lenses is CA_Max, and a smallest effective aperture among the effective apertures of the object-side surfaces and the sensor-side surfaces of the first to seventh lenses is CA_Min, and at least one of the following equations satisfies:
$$2 < L1\_CT / L3\_CT < 5$$
$$1 < CA\_Max / CA\_min < 5 .$$

5. The optical system of claim 4, wherein the sensor-side surface of the second lens has a minimum effective aperture among the effective apertures of the first to seventh lenses.

6. The optical system of claim 1, wherein an average value of effective apertures of the object-side surface and the sensor-side surface of the seventh lens is AVR_CA_L7, an average value of effective apertures the object-side surface and the sensor-side surface of the second lens is AVR_CA_L2, and the second and seventh lenses satisfy the following equation:
$$2 < AVR\_CA \_L7 / AVR\_CA \_L2 < 4 .$$

7. The optical system of claim 1, wherein an object-side surface of the sixth lens has a convex shape on the optical axis, and a sensor-side surface of the sixth lens has a convex shape on the optical axis,
wherein the sixth lens has positive (+) refractive power,
wherein an object-side surface of the seventh lens has a concave shape on the optical axis and a sensor-side surface has a concave shape on the optical axis.

8. The optical system of claim 1, wherein a thickness of the first lens at the optical axis is L1_CT, a thickness of the seventh lens at the optical axis is L7_CT, a distance (mm) in the optical axis between the second lens and the third lens is d23_CT, a distance (mm) in the optical axis between the sensor-side surface of the sixth lens and the object-side surface of the seventh lens is d67_CT, and the first and second lenses and the sixth and seventh lenses, and wherein the seventh lens and seventh lenses satisfy the following equations:
$$1 < L1\_CT / L7\_CT < 5$$
$$1 < d67\_CT / d23\_CT < 4 .$$

9. The optical system of claim 1, wherein a sensor-side surface of the seventh lens has an inflection point, and the inflection point is at a position of 30% or more of a distance from the optical axis to an end of an effective region the seventh lens,
wherein the following equation satisfies:
0.5<L7S2_max_sag to Sensor<2
(L7S2_max_sag to Sensor is a distance in a direction of the optical axis from a maximum Sag value of the sensor-side surface of the seventh lens to the image sensor.).

10. An optical system comprising:
a first lens group having at least two lenses facing from an object side to a sensor side; and
a second lens group disposed on a sensor side of the second lens group and having more lenses than the number of lenses of the first lens group,
wherein the at least two lenses of the first lens group are bonded,
wherein a focal length of the first lens group has a positive (+) value,
wherein a total number of lenses included in the first and second lens groups is 7 or less,
wherein a maximum distance between the first and second lens groups is an optical axis distance between the first and second lens groups,
wherein a minimum distance between the first and second lens groups is smaller than the optical axis distance between the first and second lens groups.

11. The optical system of claim 10, wherein the first lens group includes an object-side first lens and a sensor-side second lens,
wherein a sensor-side surface of the first lens has a concave shape on the optical axis,
wherein a distance in the optical axis between the first lens and the second lens is d12_CT, a distance in the optical axis direction between an end of an effective region between the first lens and the second lens is d12_ET, and
wherein the following equation satisfies:
$$0.01 > d12\_CT - d12\_ET .$$

12. The optical system of claim 11, wherein an effective aperture of a sensor-side surface closest to the second lens group among lens surfaces of the first lens group is minimum,
wherein an effective aperture of a sensor-side surface closest to an image sensor among lens surfaces of the second lens group is maximum,
wherein a distance in the optical axis from an apex of an object-side surface of the first lens to an image surface of the image sensor is TTL,
wherein a maximum diagonal length of the image sensor is IH, and
wherein the following equation satisfies:
$$0.6 < TTL / IH < 0.8 .$$

13. The optical system of claim 10, wherein an absolute value of a focal length of each of the first and second lens groups is greater in the second lens group.

14. The optical system of claim 10, wherein the first lens group includes first to second lenses disposed along the optical axis in the direction from an object side to a sensor side,
wherein the second lens group includes third to seventh lenses disposed along the optical axis in the direction from the object side to the sensor side,
wherein a sensor-side surface of the first lens and an object-side surface of the second lens are joined,
wherein a sensor-side surface of the second lens has a minimum effective aperture.

15. The optical system of claim 14, wherein an optical axis distance between the second lens and the third lens is d23_CT, an optical axis distance between a sensor-side surface of the sixth lens and an object-side surface of the seventh lens is d67_CT, and an optical axis distance between the sixth and seventh lenses, and
wherein the optical axis distance between the second and third lenses satisfies the following equation:
$$1 < d67\_CT / d23\_CT < 4.$$

16. The optical system of claim 14, wherein the second lens has a negative refractive power different from the refractive power of the first lens, a refractive index higher than the refractive index of the first lens, an Abbe number lower than the Abbe number of the first lens, and the refractive indices of the first and second lenses are n1 and n2, and Abbe numbers of the first and second lenses are v1 and v2, and the following equations satisfy:
$$0.05 < ( n 2 ) - ( n 1 ) < 0 \text{.25}$$
$$1.45 < n 1 < 1.65$$
$$1.55 < n 2 < 1.8$$
$$10 < ( v 1 ) - ( v 2 ) < 50 .$$

17. The optical system of claim 10, wherein a thickness of the first lens group at the optical axis is equal to a sum of the thicknesses of the at least two lenses.

18. The optical system of claim 10, wherein a thickness at an end of the effective region of the first lens group is equal to a distance between ends of effective regions of the at least two lenses.

19. The optical system of claim 10, wherein the first lens group consists of two lenses bonded together, and the second lens group consists of five lenses.

20. A camera module comprising:
an image sensor; and
a filter between the image sensor and a last lens of an optical system,
wherein the optical system includes an optical system according to claim 1,
wherein the total focal length of the optical system is F, an entrance pupil diameter of the optical system is EPD, and a camera module that satisfies the following equation:
$$1 \leq F / EPD < 5 .$$
